(19) United States
(12) Patent Application Publication
(10) Pub. No.: US 2018/0211380 A1
(43) Pub. Date: Jul. 26, 2018

(54) CLASSIFYING BIOLOGICAL SAMPLES USING AUTOMATED IMAGE ANALYSIS

(71) Applicant: Athelas Inc., Saratoga, CA (US)

(72) Inventors: Tanay Tandon, Saratoga, CA (US); Deepika Bodapati, Saratoga, CA (US); Utkarsh Tandon, Saratoga, CA (US)

(21) Appl. No.: 15/415,775

(22) Filed: Jan. 25, 2017

(51) Int. Cl. G06T 7/00

(52) U.S. Cl. CPC G06T 7/0012; G06K 9/6267

(57) ABSTRACT

A system for imaging biological samples and analyzing images of the biological samples is provided. The system can automatically analyze images of biological samples to classify cells of interest using machine learning techniques. Some implementations can diagnose diseases associated with specific cell types. Devices, methods, and computer program product for imaging and analyzing biological samples are also provided.

### BACKGROUND

More than 1.5 million people in rural regions die every year due to undiagnosed, yet highly treatable parasitical infections such as Malaria, Chagas, and Toxoplasmosis. Rural regions lack access to expensive in-lab diagnostic equipment and trained pathologists for disease detection. Further, most existing techniques require microscopes' device(s) for visually diagnosing conditions. In addition to setting up expensive lab diagnostic equipment, there is also a need to move skilled labor to the rural regions affected by the infections. Thus, due to inadequate access and supply of the necessary equipment and skilled personnel, millions of potentially treatable cases go undiagnosed, leading to high parasite mortality rates, especially in rural regions.

Conventional systems and methods for imaging and analyzing samples require a microscopy setup operated by a human or by using brute force image analysis algorithms with specific rules for each sample type. Such systems and methods do not generalize well across samples and require manual analysis of a sample which frequently provides inaccurate results. More sophisticated sample analysis methodologies use a one or more of spectroscopy, flow-cytometry, electrical impedance, chemical assays, and similar lab techniques to classify, analyze, and diagnose a sample. Unfortunately, such techniques introduce expense that cannot be justified in certain contexts such as certain rural settings. Further some of the more sophisticated techniques use rule-based computer vision that requires specific heuristics or instructions for different samples.

### SUMMARY

The present invention relates to methods, systems and apparatus for imaging and analyzing a biological sample of a host organism to identify a sample feature of interest, such as a cell type of interest.

One aspect of the disclosure relates to a system for identifying a sample feature of interest in a biological sample of a host organism. The system includes: a camera configured to capture one or more images of the biological sample; and one or more processors communicatively connected to the camera. The one or more processors are configured to: receive the one or more images of the biological sample captured by the camera; segment the one or more images of the biological sample to obtain a plurality of cellular artifacts; apply a machine-learning classification model to the plurality of images of cellular artifacts to classify the cellular artifacts; and determine that at least one of the classified cellular artifacts belongs to a class to which the sample feature of interest belongs.

In some implementations, the sample feature of interest is associated with a disease. In some implementations, the one or more processors are further configured to diagnose the disease in the host organism based at least partly on determining that the at least one of the classified cellular artifacts belongs to the class to which the sample feature of interest belongs. In some implementations, the diagnosis of the disease in the host organism is further based on a quantity of the classified cellular artifacts obtained from the image that belong to the same class as the sample feature of interest.

In some implementations, the machine-learning classification model includes a convolutional neural network classifier. In some implementations, applying the machine-learning classification model to the plurality of images of cellular artifacts to classify the cellular artifacts includes: applying a principal component analysis (PCA) to the plurality of images of cellular artifacts to obtain a plurality of feature vectors for the plurality of cellular artifacts; and applying a random forest classifier to the plurality of feature vectors for the plurality of cellular artifacts to classify the cellular artifacts.

In some implementations, the one or more processors are further configured to: receive a plurality of images of training cellular artifacts and classification data of the training cellular artifacts, wherein one or more of the training cellular artifacts belong to the same class as the sample feature of interest; apply the principal component analysis to the plurality of training images of cellular artifacts to obtain a plurality of feature vectors for the plurality of training cellular artifacts; and train the random forest classifier using the plurality of feature vectors for the plurality of training cellular artifacts and the classification data of the training cellular artifacts. In some implementations, the PCA includes a randomized PCA.

In some implementations, the sample feature of interest is selected from abnormal host cells or parasites infecting the host. In some implementations, the parasites infecting the host are selected from bacteria, fungi, protozoa, helminths, and any combinations thereof. In some implementations, the protozoa are any of the following: Plasmodium, Trypanosoma, and Leishmania.

In some implementations, the biological sample is from sputum or oral fluid, amniotic fluid, blood, a blood fraction, fine needle biopsy samples, urine, semen, stool, vaginal fluid, peritoneal fluid, pleural fluid, tissue explant, organ culture, cell culture, tissue or cell preparation, any fraction or derivative thereof or isolated therefrom, and any combination thereof.

In some implementations, the host is selected from mammals, reptiles, amphibians, birds, and fish.

In some implementations, the one or more images of the biological sample include one or more images of a sample smear of the biological sample. In some implementations, the sample smear of the biological sample includes a mono-cellular layer of the biological sample.

In some implementations, segmenting the one or more images of the biological sample includes converting the one or more images of the biological sample from color images to grayscale images. In some implementations, segmenting the one or more images of the biological sample further includes converting the grayscale images to binary images using Otsu thresholding. In some implementations, segmenting the one or more images of the biological sample further includes performing a Euclidean distance transformation. In some implementations, segmenting the one or more images of the biological sample further includes identifying local maxima of pixel values obtained from the Euclidian distance transformation. In some implementations, segmenting the one or more images of the biological sample further includes applying a Sobel filter to the one or more images of the biological sample or images derived therefrom.

In some implementations, segmenting the one or more images of the biological sample further includes splicing the one or more images of the biological sample using the local maxima and data obtained from applying the Sobel filter, thereby obtaining the plurality of images of the cellular artifacts. In some implementations, the spliced one or more images of the biological sample include color images, and the plurality of images of the cellular artifacts include color images.

In some implementations, the machine learning classification model is configured to classify the cellular artifacts as belonging to a white blood cell, a red blood cell, or a parasite.

In some implementations, the machine learning classification model is configured to classify white blood cells as neutrophils, eosinophils, monocytes, basophils, and lymphocytes.

In some implementations, the one or more processors are further configured to determine a property, other than classifying cellular artifacts, of the biological sample from the one or more images. In some implementations, the property other than classifying cellular artifacts includes an absolute or differential count of at least one type of cell. In some implementations, the property other than classifying cellular artifacts includes a color of the biological sample or the presence of precipitates in the biological sample.

Another aspect of the disclosure relates to a system for imaging a biological sample of a host organism. The system includes: a stage configured to receive the biological sample; a camera configured to capture one or more images of the biological sample received by the stage; one or more actuators coupled to the camera and/or the stage; and one or more processors communicatively connected to the camera and the one or more actuators. The one or more processors are configured to: receive the one or more images of the biological sample captured by the camera, segment the one or more images of the biological sample to obtain one or more images of cellular artifacts, and control, based on data obtained from the one or more images of cellular artifacts, the one or more actuators to move the camera and/or the stage in a first dimension.

In some implementations, the angle formed between the first dimension and a focal axis of the camera is in the range from about 45 degrees to 90 degrees. In some implementations, the first dimension is about perpendicular to the focal axis of the camera.

In some implementations, the one or more processors are further configured to control, based on the data obtained from the one or more images of cellular artifacts, the one or more actuators to move the camera and/or the stage in a second dimension perpendicular to both the first dimension and the focal axis of the camera. In some implementations, the one or more processors are further configured to control, based on the data obtained from the one or more images of cellular artifacts, the one or more actuators to move the camera and/or the stage in a third dimension parallel to the focal axis of the camera. In some implementations, the one or more processors are further configured to change, based on the data obtained from the one or more images of the cellular artifacts, the focal length of the camera.

In some implementations, the one or more actuators include one or more linear actuators.

In some implementations, segmenting the one or more images of the biological sample includes converting the one or more images of the biological sample from color images to grayscale images. In some implementations, segmenting the one or more images of the biological sample further includes converting the grayscale images to binary images using Otsu thresholding. In some implementations, segmenting the one or more images of the biological sample further includes performing Euclidian distance transformation of the binary images.

In some implementations, segmenting the one or more images of the biological sample further includes identifying local maxima of pixel values after the Euclidian distance transformation. In some implementations, segmenting the one or more images of the biological sample further includes applying a Sobel filter to the one or more images of the biological sample or images derived therefrom.

In some implementations, controlling the one or more actuators to move the camera and/or the stage in the first dimension includes: processing the one or more images of the cellular artifacts to obtain at least one measure of the one or more images of the cellular artifacts; determining that the at least one measure of the one or more images of the cellular artifacts is in a first range; and controlling the one or more actuators to move the camera and/or the stage, based on the at least one measure being in the first range, in a first direction in the first dimension.

In some implementations, controlling the one or more actuators to move the camera and/or the stage in the first dimension further includes: determining that the at least one measure of the one or more images of the cellular artifacts is in a second range different from the first range; and controlling the one or more actuators to move the camera and/or the stage, based on the at least one measure being in the second range, in a second direction different from the first direction in the first dimension.

In some implementations, controlling the one or more actuators to move the camera and/or the stage in the first dimension includes: processing a plurality of images of the cellular artifacts to obtain a plurality of measures of the plurality of images of the cellular artifacts; and controlling the one or more actuators to move the camera and/or the stage, based on the plurality of measures of the plurality of images of the cellular artifacts, in the first dimension.

A further aspect of the disclosure relates to methods for identifying a sample feature of interest in a biological sample of a host organism, implemented with a system including one or more processors. In some implementations, the method includes: obtaining one or more images of the biological sample, wherein the images were obtained using a camera; segmenting, by the one or more processors, the one or more images of the biological sample to obtain a plurality of images of cellular artifacts; applying, by the one or more processors, a machine-learning classification model to the plurality of images of cellular artifacts to classify the cellular artifacts; and determining, by the one or more processors, that at least one of the classified cellular artifacts belongs to a class to which the sample feature of interest belongs.

In some implementations, the sample feature of interest is associated with a disease. In some implementations, the one or more processors are further configured to diagnose the disease in the host organism based at least partly on determining that the at least one of the classified cellular artifacts belongs to the class to which the sample feature of interest belongs. In some implementations, the diagnosing the disease in the host organism is further based on a quantity of the classified cellular artifacts belonging to the same class as the sample feature of interest.

In some implementations, the machine-learning classification model includes a convolutional neural network classifier.

In some implementations, applying the machine-learning classification model to the plurality of images of cellular artifacts to classify the cellular artifacts includes: applying, by the one or more processors, a principal component analysis to the plurality of images of cellular artifacts to obtain a plurality of feature vectors for the plurality of cellular artifacts; and applying, by the one or more processors, a random forest classifier to the plurality of feature vectors for the plurality of cellular artifacts to classify the cellular artifacts.

In some implementations, the method further includes, before applying the machine-learning classification model to the plurality of images of cellular artifacts: receiving, by at least one processor, a plurality of images of training cellular artifacts and classification data of the training cellular artifacts, wherein one or more of the training cellular artifacts belong to the same class as the sample feature of interest; applying, by the at least one processor, the principal component analysis to the plurality of training images of cellular artifacts to obtain a plurality of feature vectors for the plurality of training cellular artifacts; and training, by the at least one processor, the random forest classifier using the plurality of feature vectors for the plurality of training cellular artifacts and the classification data of the training cellular artifacts.

In some implementations, the at least one processor and the one or more processors include different processors.

In some implementations, the sample feature of interest is selected from the group consisting of: abnormal host cells, parasites infecting the host, and a combination thereof.

In some implementations, the parasites infecting the host are selected from the group consisting of bacteria, fungi, protozoa, helminths, and any combinations thereof.

In some implementations, the protozoa are selected from the group consisting of Plasmodium, Trypanosoma, Leishmania, and any combination thereof.

In some implementations, applying the machine learning classification model classifies the cellular artifacts as belonging to a white blood cell, a red blood cell, or a parasite.

In some implementations, applying the machine learning classification model classifies white blood cells as neutrophils, eosinophils, monocytes, basophils, and lymphocytes.

In some implementations, the method further includes determine a property, other than classifying cellular artifacts, of the biological sample from the one or more images. In some implementations, the property other than classifying cellular artifacts includes an absolute or differential count of at least one type of cell. In some implementations, the property other than classifying cellular artifacts includes a color of the biological sample or the presence of precipitates in the biological sample.

An additional aspect of the disclosure relates to a non-transitory computer-readable medium storing computer-readable program code to be executed by one or more processors, the program code including instructions to cause a system including a camera and one or more processors communicatively connected to the camera to: obtain the one or more images of the biological sample captured using the camera; segment, by the one or more processors, the one or more images of the biological sample to obtain a plurality of images of cellular artifacts; apply, by the one or more processors, a machine-learning classification model to the plurality of images of cellular artifacts to classify the cellular artifacts; and determine, by the one or more processors, that at least one of the classified cellular artifacts belongs to a class to which the sample feature of interest belongs.

Another aspect of the disclosure relates to a system including: a smear producing device configured to receive a biological sample and spread it over a substrate to separate sample features of the biological sample such that the features can be viewed at different regions of the substrate; a smear imaging device configured to take one more images that collectively capture all or a portion of the smear as provided on the substrate; a deep learning classification model including computer readable instructions for executing on one or more processors. The instructions cause the processors to: receive the one or more images from the smear imaging device; segment the one or more images to identify groups of pixels containing images of sample features from the images, wherein each group of pixels includes a cellular artifact; and classify some or all of the cellular artifacts using the deep learning classification model, wherein the classification model discriminates between cellular artifacts created from images of at least one cell type of the host and images of at least one non-host feature.

In some implementations, when executing, the computer readable instructions segment the one or more images by (i) filtering background portions of the image and (ii) identifying contiguous groups of pixels in the foreground including the cellular artifacts.

In some implementations, the computer readable instructions include instructions, which when executing, classify the cellular artifacts according to non-host features selected from the group consisting of protozoa present in the host, bacteria present in the host, fungi present in the host, helminths present in the host, and viruses present in the host.

A further aspect of the disclosure relates to a test strip for producing a smear of a liquid biological sample. The test strip includes: a substrate with a capillary tube disposed thereon, wherein the capillary tube is sized to form a smear of the biological sample when the biological sample enters the capillary tube; a dye coated on at least a portion of the substrate, wherein the dye stains a particular cell type from the biological sample when the biological sample contacts the dye; and a sample capture pathway disposed on the substrate and configured to receive the liquid biological sample onto the substrate and place the biological sample in contact with the dry dye and/or into the capillary tube where it forms a smear suitable for imaging.

In some implementations, in some implementations, the dye is a dry dye. In some implementations, the dry dye includes methylene blue and/or cresyl violet.

In some implementations, the test strip further includes a lysing agent for one or more cells present in the biological sample, wherein the lysing agent is provided on at least the sample capture pathway or the capillary. In some implementations, the lysing agent includes a hemolysing agent.

In some implementations, the sample capture pathway includes a coverslip.

In some implementations, the test strip further includes multiple additional capillaries disposed on the substrate. In some implementations, each of the capillaries disposed on the substrate. includes a different dye.

In some implementations, the test strip further includes registration marks on the substrate, wherein the marks are readable by an imaging system configured to generate separate images of the smears in the capillaries.

In some implementations, the capillary tube is configured to produce a monolayer of the biological sample.

Computer program products and computer systems for implementing any of the methods mentioned above are also provided. These and other aspects of the invention are described further below with reference to the drawings.

### BRIEF DESCRIPTION OF THE DRAWINGS

FIG. 1 shows an example of a design of test strip used in some implementations.

FIG. 2 shows another example of a design of test strip used in some implementations.

FIG. 3 shows a further example of a design of test strip used in some implementations.

FIG. 4A is a block diagram showing components of an imaging system for imaging a biological samples.

FIG. 4B is an illustrative diagram of an imaging system for imaging biological samples.

FIG. 5 is a block diagram of a process for controlling an imaging system.

FIG. 6 illustrates a white blood cell count analyzer.

FIG. 7 illustrates an overview of training procedure of a classification model.

FIG. 8 illustrates a training directory structure.

FIG. 9 illustrates a training directory with image jpeg shots used for training.

FIG. 10 illustrates a generated intensity map and a histogram of gray values taken from a biological sample image.

FIG. 11 illustrates a bi-modal histogram using Otsu's method for threshold identification.

FIG. 12 illustrates Otsu derived threshold of pixel darkness for smear image.

FIG. 13 illustrates a simulated cell body using Euclidean Distance Transformation.

FIG. 14 is a graph showing the surface intensity of simulated cell body.

FIG. 15 illustrates a simulated RBC cell sample using Euclidean Distance Transformation.

FIG. 16 is a graph showing the intensity plot of a simulated red blood cell.

FIG. 17 illustrates a simple matrix Euclidean distance transformation for n dimensional space.

FIG. 18 illustrates a smear image obtained using the Otsu derived thresholding.

FIG. 19 illustrates the Euclidean distance transformation of Otsu derived threshold for the smear image.

FIG. 20 illustrates the local maxima peaks in a two-dimensional numpy array.

FIG. 21 illustrates a full smear maxima surface plot.

FIG. 22 illustrates a generated elevation map for a blood smear.

FIG. 23 illustrates segmentation and splicing processes.

FIG. 24 is a block diagram of a process for identifying a sample feature of interest.

FIG. 25 illustrates a segmentation process.

FIG. 26 illustrates the code snippet of high-level randomized PCA process.

FIG. 27 schematically illustrates an image normalized to 50×50 jpeg images.

FIG. 28A-28C illustrate how a random forests classifier can be built and applied to classify feature vectors of cellular artifact images.

FIG. 29 shows data of a white blood cell analyzer with a linear trend.

FIG. 30 plots cell count results using an implemented method versus using a Beckman Coulter Counter method.

### DESCRIPTION

Terminology

Unless otherwise indicated, the method operations and device features disclosed herein involves techniques and apparatus commonly used in microbiology, geometric optics, software design and programming, and statistics, which are within the skill of the art. Such techniques and apparatus are known to those of skill in the art and are described in numerous texts and reference works.

Unless defined otherwise herein, all technical and scientific terms used herein have the same meaning as commonly understood by one of ordinary skill in the art. Various scientific dictionaries that include the terms included herein are well known and available to those in the art. Although any methods and materials similar or equivalent to those described herein find use in the practice or testing of the embodiments disclosed herein, some methods and materials are described.

Numeric ranges are inclusive of the numbers defining the range. It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The headings provided herein are not intended to limit the disclosure.

As used herein, the singular terms “a,” “an,” and “the” include the plural reference unless the context clearly indicates otherwise. The term “or” as used herein, refers to a non-exclusive or, unless otherwise indicated.

The terms defined immediately below are more fully described by reference to the specification as a whole. It is to be understood that this disclosure is not limited to the particular methodology, protocols, and reagents described, as these may vary, depending upon the context they are used by those of skill in the art.

The term “plurality” refers to more than one element. For example, the term is used herein in reference to more than one type of parasite in a biological sample; more than one sample feature (e.g., a cell) in an image of a biological sample or smear of the biological sample; more than one layer in a deep learning model; and the like.

The term “parameter value” herein refers to a numerical value that characterizes a physical property or a representation of that property. In some situations, a parameter value numerically characterizes a quantitative data set and/or a numerical relationship between quantitative data sets. For example, the mean and variance of a standard distribution fit to a histogram are parameter values.

The terms “threshold” herein refer to any number that is used as, e.g., a cutoff to classify a sample feature as particular type of parasite, or a ratio of abnormal to normal cells (or a density of abnormal cells) to diagnose a condition related to abnormal cells, or the like. The threshold may be compared to a measured or calculated value to determine whether the source giving rise to such value suggests that it should be classified in a particular manner. Threshold values can be identified empirically or analytically. The choice of a threshold is dependent on the level of confidence that the user wishes to have to make the classification. Sometimes they are chosen for a particular purpose (e.g., to balance sensitivity and selectivity).

The term “biological sample” refers to a sample, typically derived from a biological fluid, tissue, organ, etc., often taken from an organism suspected of having a condition such as an infection, neoplasm, mutation, or aneuploidy. Such samples include, but are not limited to sputum/oral fluid, amniotic fluid, blood, a blood fraction, fine needle biopsy samples (e.g., surgical biopsy, fine needle biopsy, etc.), urine, semen, stool, vaginal fluid, peritoneal fluid, pleural fluid, tissue explant, organ culture, cell culture, and any other tissue or cell preparation, or fraction or derivative thereof or isolated therefrom. The biological sample may be taken from a multicellular organism or it may be of one or more single cellular organisms. In some cases, the biological sample is taken from a multicellular organism and includes both cells comprising the genome of the organism and cells from another organism such as a parasite. The sample may be used directly as obtained from the biological source or following a pretreatment to modify the character of the sample. For example, such pretreatment may include preparing plasma from blood, diluting viscous fluids, culturing cells or tissue, and so forth. Methods of pretreatment may also involve, but are not limited to, filtration, precipitation, dilution, distillation, mixing, centrifugation, freezing, lyophilization, concentration, amplification, nucleic acid fragmentation, inactivation of interfering components, the addition of reagents, lysing, etc. Such “treated” or “processed” samples are still considered to be biological samples with respect to the methods described herein.

Biological samples can be obtained from any subject or biological source. Although the sample is often taken from a human subject (e.g., a patient), samples can be taken from any organism, including, but not limited to mammals (e.g., dogs, cats, horses, goats, sheep, cattle, pigs, etc.), non-mammal higher organisms (e.g., reptiles, amphibians), vertebrates and invertebrates, and may also be or include any single-celled organism such as a eukaryotic organism (including plants and algae) or a prokaryotic organism, archaeon, microorganisms (e.g. bacteria, archaea, fungi, protists, viruses), and aquatic plankton.

In various embodiments described herein, a biological sample is taken from an individual or “host.” Such samples may include any of the cells of the host (i.e., cells having the genome of the individual) or host tissue along with, in some cases, any non-host cells, non-host multicellular organisms, etc. described below. In various embodiments, the biological sample is provided in a format that facilitates imaging and automated image analysis. As an example, the biological sample may be stained and/or converted to a smear before image analysis.

Host—An organism providing the biological sample. Examples include higher animals including mammals, including humans, reptiles, amphibians, and other sources of biological samples as presented above.

Sample Feature—A sample feature is a feature of the biological sample that represents a potentially clinically interesting condition. In certain embodiments, a sample feature is a feature that appears in an image of a biological sample and can be segmented and classified by a machine learning model. Examples of sample features include the following:
Cells of the host (including both normal and abnormal host cells; e.g., tumor and normal somatic cells) include red blood cells (nucleated and anucleated), white blood cells, somatic non-blood cells, circulating tumor cells of any tissue type, and the like. Types of white blood cells include neutrophils, lymphocytes, basophils, monocytes, and eosinophils.
Parasitical organisms present in the host include both obligate parasites, which are completely dependent on host to complete their life cycles, and facultative parasites, which can be operational outside the host. In some cases, the classifiers described herein classify only parasites that are endoparasites; i.e., parasites that live inside their hosts rather than on the skin or outgrowths of the skin. Types of endoparasites that can be classified by methods and apparatus described herein include intercellular parasites (inhabiting spaces in the host's body, including the blood plasma) and intercellular parasites (inhabiting spaces in the host's body, including the blood plasma). An example of an intercellular parasite is Babesia, a protozoan parasite that can produce malaria-like symptoms. Examples of intracellular parasites include protozoa (eukaryotes), bacteria (prokaryotes), and viruses. A few specific examples follow:

(a) Protozoa; these may be worms; examples of obligate protozoa include:
Apicomplexans (Plasmodium spp. including Plasmodium falciparum (malarial parasite) and Plasmodium vivax),
Toxoplasma gondii and Cryptosporidium parvum) (toxoplasmosis parasite)
Trypanosomatids (Leishmania spp. and Trypanosoma cruzi) (chagas parasite)
Cytauxzoon felis
Schistosoma

(b) Bacterial examples include:
(i) Facultative examples
   Bartonella henselae
   Francisella tularensis
   Listeria monocytogenes
   Salmonella typhi
   Brucella
   Legionella
   Mycobacterium
   Nocardia
   Rhodococcus equi^{[}
   Yersinia
   Neisseria meningitidis
   Filariasis
   Mycoplasma
(ii) Obligate examples:
   Chlamydia, and closely related species.
   Rickettsia
   Coxiella
   Certain species of Mycobacterium such as Mycobacterium leprae
   Anaplasma phagocytophilum

(c) Fungi—examples include:
(i) Facultative examples
   Histoplasma capsulatum
   Cryptococcus neoformans
   Yeast/saccharamyces
(ii) Obligate examples
   Pneumocystis jirovecii

(d) Viruses (these are typically obligate and some are large enough to be identified by the resolution of the imaging system)

(e) Helminths
Flatworms (platyhelminths)—these include the trematodes (flukes) and cestodes (tapeworms).
Thorny-headed worms (acanthocephalins)—the adult forms of these worms reside in the gastrointestinal tract.
Roundworms (nematodes)—the adult forms of these worms can reside in the gastrointestinal tract, blood, lymphatic system or subcutaneous tissues.

Additional classifications are possible based on morphological differences that are detectable using image analysis systems as described herein. For example, the protozoa that are infectious to humans can be classified into four groups based on their mode of movement:

Sarcodina—the ameba, e.g., Entamoeba

Mastigophora—the flagellates, e.g., Giardia, Leishmania

Ciliophora—the ciliates, e.g., Balantidium

Sporozoa—organisms whose adult stage is not motile e.g., Plasmodium, Cryptosporidium

Each example of the sample features presented above can be used as a separate classification for the machine learning systems described herein. Such systems can classify any of these alone or in combination with other examples.

Smear—a thin layer of blood or other biological sample provided in a form that facilitates imaging to highlight sample features that can be analyzed to automatically classify the sample features. Often a smear is provided on a substrate that facilitates conversion of a raw biological sample taken from a host to a thin image-ready form (the smear). In certain embodiments, the smear has a thickness of at most about 50 micrometers or at most about 30 micrometers. In some embodiments, smear thickness is between about 10 and 30 micrometers. In various embodiments, the smear presents cells, multicellular organisms, and/or other features of biological significance in a monolayer, such that only a single feature exists (or appears in an image) at any x-y position in the image. However, the disclosure is not limited to smears that present sample features in a monolayer; for example, the biological sample in a smear may be thicker than a monolayer. However, it is desirable that the smear present sample features in a form that can be imaged with sufficient detail that an image analysis routine as described herein can reliably classify the sample features. Therefore, in many embodiments, the smear presents sample features with sufficient clarity to resolve the entire boundaries of the sample features and some interior variations within the boundaries.

Actuator—An actuator is a component of system that is responsible for moving or controlling a mechanism of the system such as an optical imaging system. An actuator requires a control signal and a source of energy. The control signal has relatively low power. When the control signal is received, the actuator responds by converting the source energy into mechanical motion. Based on the different types of energy sources, actuators may be classified as hydraulic actuators, pneumatic actuators, electric actuators, thermal actuators, magnetic actuators, mechanical actuators, etc. Regarding motion patterns generated by the actuator, actuators include rotary actuators and linear actuators. A linear actuator is an actuator that creates motion in a straight line, in contrast to the circular motion of a conventional electric motor. Linear actuators may be implemented as mechanical actuators, hydraulic actuators, pneumatic actuators, piezoelectric actuators, electro-mechanical actuators, linear motors, telescoping linear actuator, etc.

Optical axis—An optical axis is a line along which there is some degree of rotational symmetry in an optical system such as a camera lens or microscope. The optical axis is an imaginary line that defines the path along which light propagates through the system, up to a first approximation. For a system composed of simple lenses and mirrors, the axis passes through the center of curvature of each surface, and coincides with the axis of rotational symmetry.

Segmentation—Segmentation is an image analysis process that identifies individual sample features, and particularly cellular artifacts, in an image of a smear or other form of a biological sample. In various embodiments, segmentation removes background pixels (pixels deemed to be unassociated with any sample feature) and groups of foreground pixels into cellular artifacts, which can then be extracted and fed to a classification model. In this process, segmentation may define boundaries in an image of the cellular artifacts. The boundaries may be defined by collections of Cartesian coordinates, polar coordinates, pixel IDs, etc. Segmentation will be further described in the segmentation section herein.

Cellular artifact—A cellular artifact is any item in an image of a biological sample that is identified—typically by segmentation—that might qualify as a cell, parasite or other sample feature of interest. An image of a sample feature may be converted to a cellular artifact. From an image processing perspective, a cellular artifact represents a collection of contiguous pixels (with associated position and magnitude values) that are identified as likely belonging to a cell, parasite, or other sample feature of interest in a biological sample. Typically, the collection of contiguous pixels is within or proximate to a boundary defined through segmentation. Often, a cellular artifact includes pixels of an identified boundary, all pixels within that boundary, and optionally some relatively small number of pixels surrounding the boundary (e.g., a penumbra around the periphery of the sample feature). Some items that are initially determined through segmentation to be cellular artifacts are pollutants that that are irrelevant to the classification. Typically, though not necessarily, the model is not trained to uniquely identify pollutants. Due to the shape and size of a typical cellular artifact, it is sometimes referred to as a “blob.”

Pollutant—a small particulate body found in a biological sample. Typically, it is not considered a sample feature. When a pollutant appears in an image of a smear, it may be initially deemed cellular artifact. Upon image analysis, a pollutant may be characterized as a peripheral object, or simply not classified, by a machine learning model.

Morphological feature—A morphological feature is a geometric characteristic of a cellular artifact that may be useful in classifying the sample feature giving rise to the cellular artifact. Examples of morphological features include shape, circularity, texture, and color. In various embodiments, machine learning models used herein do not receive any morphological characteristics as inputs. In various embodiments, machine learning models used herein do not output morphological features. Rather, the machine learning models can classify cellular artifacts without explicit regard to morphological features, although intrinsically the models may employ morphological features.

Machine learning model—A machine learning model is a trained computational model that takes cellular artifacts extracted from an image and classifies them as, for example, particular cell types, parasites, bacteria, etc. Cellular artifacts that cannot be classified by the machine learning model are deemed peripheral or unidentifiable objects. Examples of machine learning models include a random forests models, including deep random forests, neural networks, including recurrent neural networks and convolutional neural networks, restricted Boltzmann machines, recurrent tensor networks, and gradient boosted trees. The term “classifier” (or classification model) is sometimes used to describe all forms of classification model including deep learning models (e.g., neural networks having many layer) as well as random forests models.

Deep learning model—A deep learning model as used herein is a form of classification model. It is also a form of machine learning model. It may be implemented in various forms such as by a neural network (e.g., a convolutional neural network), etc. In general, though not necessarily, it includes multiple layers. Each such layer includes multiple processing nodes, and the layers process in sequence, with nodes of layers closer to the model input layer processing before nodes of layers closer to the model output. In various embodiments, one layers feeds to the next, etc. The output layer may include nodes that represent various classifications (e.g., granulocytes (includes neutrophils, eosinophils and basophils), agranulocytes (includes lymphocytes and monocytes), anucleated red blood cells, etc.). In some implementations, a deep learning model is a model that takes data with very little preprocessing, although it may be segmented data such as cellular artifact extracted from an image, and outputs a classification of the cellular artifact.

In various embodiments, a deep learning model has significant depth and can classify a large or heterogeneous array of cellular artifacts. In some contexts, the term “deep” means that model has more than two (or more than three or more than four or more than five) layers of processing nodes that receive values from preceding layers (or as direct inputs) and that output values to succeeding layers (or the final output). Interior nodes are often “hidden” in the sense that their input and output values are not visible outside the model. In various embodiments, the operation of the hidden nodes is not monitored or recorded during operation.

The nodes and connections of a deep learning model can be trained and retrained without redesigning their number, arrangement, interface with image inputs, etc. and yet classify a large heterogeneous range of cellular artifacts.

As indicated, in various implementations, the node layers may collectively form a neural network, although many deep learning models have other structures and formats. Some embodiments of deep learning models do not have a layered structure, in which case the above characterization of “deep” as having many layers is not relevant.

Randomized PCA—A principal component analysis (PCA) is a method of dimension reduction of complex data by projecting data onto data dimensions that account for the most amount of variance in the data, with the first principal component accounting for the largest amount, and each component being orthogonal to the last component. In some implementations, PCA is performed using a low-rank approximation of a matrix D containing the data being analyzed. The construction of the best possible rank-k approximation to a real m x n matrix D uses the singular value decomposition (SVD) of D, or D=U Σ V^{T}, where D is a real unitary m×m matrix, V^{T} is a transposed real unitary n×n matrix V, and Σ is a real m×n matrix whose only nonzero entries appear in nonincreasing order on the diagonal and are nonnegative.

A randomize PCA uses a randomized algorithm to estimate the singular value decomposition of D. The randomized algorithm involves the application of the matrix D being approximated and its transpose D^{T} to random vectors.

Random Forests Model—Random Forests is a method for multiple regression or classification using an ensemble of decision trees. Each decision tree of the ensemble is trained with a subset of data from the available training data set. At each node of a decision tree, a number of variables are randomly selected from all of the available variables to train the decision rule. When applying a train Random Forest, test data are provided to the decision trees of the Random Forest ensemble, and the final outcome is based on a combination of the outcomes of the individual decision trees. For a classification decision trees, the final class may be a majority or a mode of the outcomes of all the decision trees. For regression, the final value can be a mean, a mode, or a median. Examples and details of Random Forest methods are further described hereinafter.

Introduction: Biological Samples Classification Systems

The embodiments herein and the various features and details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Disclosed herein are automated biological sample test systems for rapid analysis of cell morphology. Such systems may be inexpensive and require relatively little skilled training. Such systems may be portable. As such and because they are easy to employ in rural regions, such systems may assist in saving individuals with undiagnosed cases by, e.g., identifying parasite presence, and analyzing hundreds of cell samples without the presence of a human pathologist.

Certain embodiments herein employ a portable system for automated blood diagnostics and/or parasite detection through a machine-learning based computer vision technique for blood cell analysis on simple camera systems such as CMOS array detectors and CCD detectors. The portable system may include a computational processing unit for image analysis that interfaces with a physical lens/imaging system and an actuator/moving stage/moving camera which allows for sample scanning while magnifying. The system may be configured to analyze the sample in an automated fashion that uses machine learning (e.g., deep learning) to diagnose, classify, and analyze features in the images to automatically generate an analysis about the sample. The imaging system may be implemented in a device designed or configured specifically for biological sample analysis application, or using, in whole or part, off-the-shelf imaging devices such as a smartphone CMOS imagers, etc. One approach employs an engineered van Leeuwenhoek type lens system attachable to the smartphone camera interfaces to image blood samples with 360× magnification and 480 uM field of view, technically classifying and counting cells in the sample. In various implementations, the computer vision system and low-cost lens imaging system provide a rapid, portable, and automated blood morphology test for, e.g., remote region disease detection, where in-lab equipment and trained pathologists are not readily available.

The disclosed portable system may be trained using a general-purpose imager using machine learning to analyze a sample and classify it for automated diagnostic and classification based on prior training data and an imager. A trained portable system may employ deep learning based image processing to automatically analyze a sample and image it in full in one shot or through staging, in either case, with or without the assistance of a human or specific heuristics.

In certain embodiments, the system employs a test strip holder, a linear actuator, an optical imager unit, and an image processing and computing module. In some implementations, a test strip is inserted into a sample insertion slot. The test strip is then moved into the correct measuring position with a linear actuator that adjusts the placement of the sample for optimal scanning and focus. The optical imager unit images and magnifies the sample. The optical imager transmits data to the image processing and computing module. The image processing and computing module contains image processing software that analyzes the image to classify and/or count biological features such as white blood cells and parasites and/or directs the linear actuator to reposition the sample for optimized scanning and focus. The image processing and computing module may output the results in any of many ways, such as to a display screen interface (e.g., an OLED screen). In some approaches, the results are obtained rapidly, e.g., within five minutes or less or within two minutes or less.

In one embodiment, a bodily fluid sample (e.g., blood) is taken from a patient/individual, placed within the system, and imaged. A machine learning model (which has been generalized and pre-trained on example images of the sample type) interfaces with the hardware component to scan the full sample images and automatically make a classification, diagnosis, and/or analysis. The disclosed system may utilize a combination of linear actuators and automated stages for the positioning of the sample to image it in full. In various implementations, the disclosed systems include low-cost, portable devices for automated blood diagnostics, parasite detection, etc. through a machine-learning based computer vision technique for blood cell analysis.

Certain embodiments employ the following operating sequence: (1) obtain a small sample of blood, (2) press the sample against a test strip where the blood is mixed with dried reagents (e.g., stain and/or lysing agent), (3) the strip is inserted into an analyzer, (4) the analyzer uses a mechanical actuator to position the sample, (5) a magnifying optic imager obtains an image of the sample, and (6) the image is processed through an image processing software. In some cases, the image processing module is stored and executes on the apparatus, which may be a portable device, as the analyzer and imager.

In some implementations, the system employs a topographical Euclidean distance transformation scheme as part of a segmentation process. In some implementations, the image analysis technique utilizes Otsu clustering for thresholding and segmentation, using, e.g., a labeled dataset of smear cells to train a random forests ensemble in, e.g., a projected 10-dimensional feature space.

In some implementations, the system employs a multivariate local maxima peak analysis and Principal Component Analysis (PCA) derived random forests (RF) classification to automatically identify parasites in blood smears or automatically identify other conditions detectable through image analysis of a biological sample. In some implementations, the system employs a trained neural network to classify sample features.

Due to paucity of clinical labs and skilled morphologists in underdeveloped regions, diseases frequently go undetected and treatment is delayed. The disclosed device can be used in such rural areas to get portable blood test results similar to that of the skilled morphologist, thus reducing undiagnosed parasite cases and severity of condition at treatment time. By mimicking the procedure of a trained morphologist in analyzing a blood sample by segmenting cells and individually conducting morphological analysis, the system successfully identifies parasites, sometimes with an accuracy approaching or exceeding human gold standard of about 0.9. Thus, the disclosed devices and models are particularly useful in underdeveloped regions where morphologists and large-scale setups are unavailable. However, the devices and models may be used in any environment.

In various embodiments disclosed herein, a classification model has, at a high level, two phases: segmentation and classification. Segmentation takes in a raw sample image (e.g., an image of smear) and identifies sample features (e.g., single cells or organisms) by producing cellular artifacts from an image of a smear. As explained below, it may accomplish this via a luminosity projection, Otsu thresholding, Euclidean Transformation, elevation mapping, local maxima analysis, and/or any combination thereof. Classification is conducted using, e.g., a deep learning neural network or a random forests ensemble with the dimensionally-reduced data from the PCA function of the segmented cell types. A trained classification model can classify unseen (to humans) features in segmented data.

Smears from Biological Samples

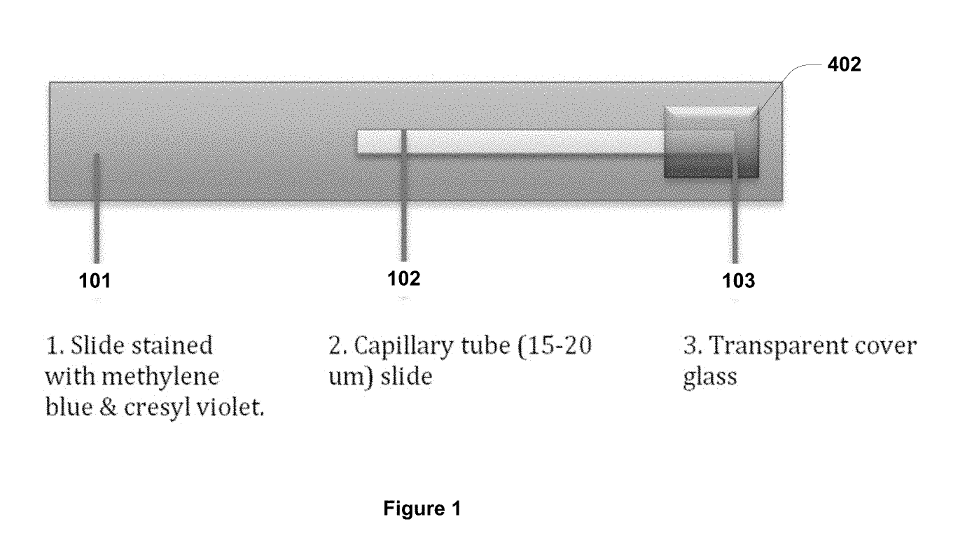

Smears of biological samples may be produced in any of various ways using various types of apparatus, some known to those of skill in the art and others novel. Examples include the test strips illustrated in FIGS. 1-3. Generally, such test strips produce a smear by simply touching a drop of blood or other sample to one side of the test strip and allowing capillary action to draw the sample into a region where it distributes in a thin layer constituting the smear. In certain embodiments, a test strip serves as both a reaction chamber for preprocessing the sample prior to imaging and a container for imaging a smear of the sample. Examples of reactions that can take place on the test strip include staining one or more components of the sample (e.g., host cells and/or parasites) and lysing one or more cells of the sample. In some embodiments, lysing is performed on cells that could interfere with the image analysis.

A test strip depicted in FIG. 1 may be implemented as a transparent sheet 101 of substantially rigid material such as glass or polycarbonate that contains a pathway for directing a sample into a region where the sample forms an image-ready smear. Transparent sheet 101 may contain or be coated with a material that reacts with one or more components of the sample. Examples of such materials include dyes, lysing agents, and fixing agents.

The test strip of FIG. 1 may function as follows. A finger is lanced and the wound is placed against a coverslip 103 on the edge of a test strip. The blood sample enters where indicated by arrow 104. Then it is forced into a smear thickness by the transparent cover slip. While the sample blood flows under coverslip 103, it interfaces with a stain and/or other reagent that has been dried on the surface of sheet 101. After the blood interfaces with the stain it is drawn into a capillary tube 102 by capillary action and forms the image-ready smear, which may be a monolayer. The capillary tube optionally includes a dye or other reagent that may also be present in the region under the coverslip.

In some implementations, the sheet 101 contains or is coated with a reagent that is a stain for the white blood cells, e.g., methylene blue and/or cresyl violet. As an example of another reagent, a hemolysing agent such as saponin may be used to lyse the red blood cells in the test strip.

In some embodiments, only a small amount of blood or other sample liquid is provided to the test strip. In certain embodiments, between about 1 and 10 μL or approximately 4 μL is required. In some embodiments, only a short time is required between contact with the sample and insertion in an image capture system. For example, less than about ten minutes or less than six minutes is needed. In certain embodiments, the entire test strip is pre-fabricated with coverslip attached, such that the user will not have to assemble anything other than just pricking their finger and placing it in front of the test strip.

The capillary tube cross-section may have any of various shapes, including rectangular, trapezoidal, triangular, circular, ellipsoidal, etc. It typically has a limited depth (cross-sectional distance from the plane parallel to the top of the test strip to the most distant point beneath the plane) that permits generation of images suitable for accurate analysis by the machine learning classification models described herein. In one example, the depth of the capillary tube is between about 10 and 40 μm or between about 15 and 30 μm. In a specific example, the capillary tube is about 20 μm in depth. In some implementations, the length of the capillary tube is between about 25 and 100 mm, or between about 30 and 70 mm. In a specific example, the capillary tube is about 50 mm long.

As examples, overall, the test strip sheets may be between about 10 and 50 mm wide and between about 40 and 100 mm long. In a specific example, a test strip is about 20 mm wide and about 60 mm long. In some embodiments, the test strip mass is between about 2 and 20 grams, or between about 5 and 15 grams, or between about 6 and 10 grams. In some implementations, the coverslips are between 5 mm and 20 mm in diameter (a substantially circular coverglass). In a specific example, the coverslip is rectangular and has a dimension of about 18×18 mm.

In certain embodiments, the test strip sheet is made from polycarbonate, glass, polydimethylsiloxane, borosilicate, clear-fused quartz, or synthetic fused silica. In some implementations, the test strip may be viewed as a package for the capillary tube so the sheet can be made of any material so long as it has an optically clear region/cutout where the capillary tube is placed.

In certain embodiments, the test strip is fabricated as follows. Material for the sheet is cut or machined to the necessary dimensions. The starting component for the sheet may be a premade microscope slides; in another approach, the starting component is a plastic piece (e.g., polycarbonate) provided in the necessary dimensions. The capillary tubes may be machined in the sheet by, e.g., computer numerical control. In some embodiments, they may be sourced from a suitable manufacturer such as VitroCom or Mountain Lakes, NJ. The coverslip may also be machined or obtained commercially (as cover glass, or glass coverslips, or plastic coverslips).

The application of the dye or other reagent(s) can be delivered in a various ways. In one example, a small quantity of dye (e.g., about 5 uL of the dye) is delivered in front of the capillary tube. In another example, about 2 uL of the stain or other reagent is taken up by the capillary tube by putting one end of the capillary tube into the stain. In another example, the stain or other reagent is smeared across the sheet by a traditional smearing mechanism (e.g., placing a small quantity of the reagent on the sheet, forming a wedge of the reagent between the sheet and a second slide, and dragging the second slide over a face sheet to evenly smear the reagent over the face of the sheet).

In certain embodiments, a test strip can be stored for at least about 20 days after the manufacturing date, and sometimes much longer (e.g., about 90 days) if stored under noted conditions (e.g., 35-70F, <90% non-condensing humidity).

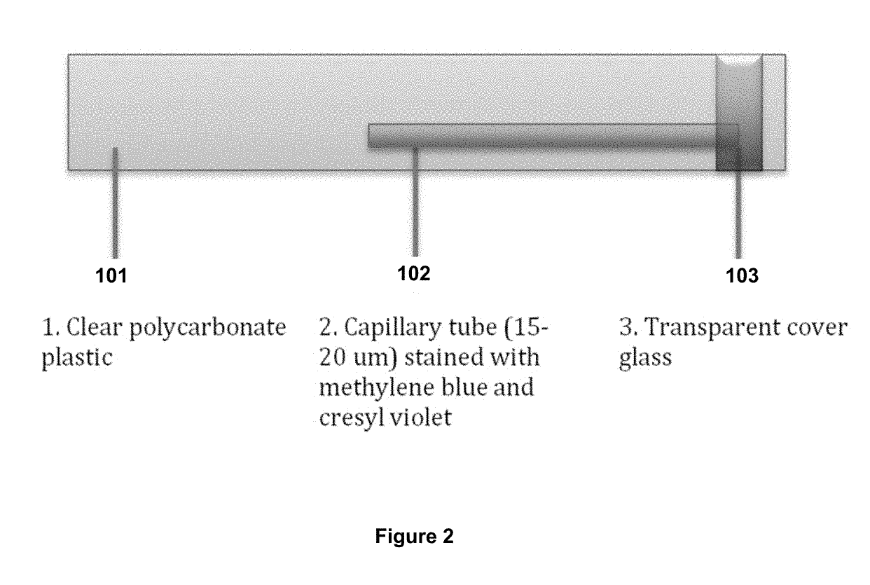

The test strip of FIG. 2 may function as follows. A finger is lanced and the wound is placed against the 103. The whole blood flows into capillary tube 102, where the stain interfaces with the blood. The capillary tube is coated on the inside with stain. Further, while the blood is flowing into the tube it is also forming into a monolayer. The sequence may be represented as follows:
1. Whole blood flows in and under the transparent coverslip creating a monolayer
2. The monolayer which is unstained at this point, then passes through the region under the cover glass, but before the capillary tube.
3. The unstained blood which is in a monolayer then enters the capillary tube. In the capillary, the blood interfaces with the stain.

The main differences in this embodiment and the previous one (FIG. 1) is the placement of stain and the region where the blood interfaces with the stain. In the FIG. 1 embodiment, the stain was coated on the slide and therefore when the blood entered the strip, under the coverslip, it interfaced with the stain and then the stained blood enters the unstained capillary tube. In the FIG. 2 embodiment, the whole blood passes under the cover slip where it is forced into a monolayer, and then it is drawn into the capillary tube. While in the capillary tube, the blood interfaces with the stain and/or any other reagent.

The embodiment of FIG. 2 may be manufactured in the same manner as the embodiment of FIG. 1. For example, the capillary tubes are machined in the same way. However, the stain or other reagent is must be applied to or through the capillary tube. This may be accomplished by putting one end of the tube dipped into the reagent. Then the alcohol or other solvent of the reagent dries depositing the reagent inside the capillary tube.

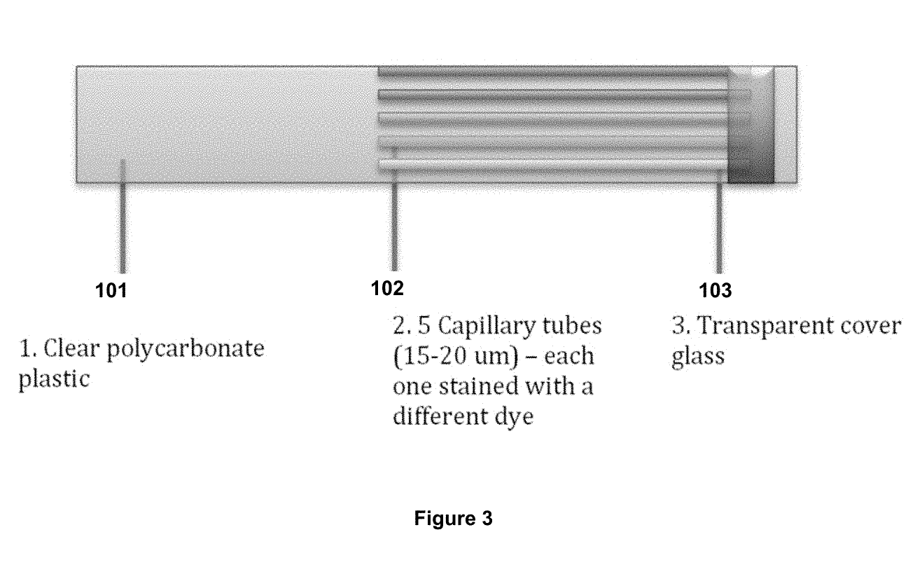

The test strip depicted in FIG. 3 may allow concurrent testing of blood as well as other fluids (peritoneal fluid, urine). The test strip is shown with multiple capillary tubes 102. A sample of fluid may be placed against 103. The fluid flows through each of the capillary tubes 102. In some implementations, only a single tube has the stain or other reagent appropriate for the sample under consideration. Only that tube with test sample is imaged.

The blood flow path is the same as in the embodiments of FIGS. 1 and 2. The blood passes under the cover slip, where it is forced into a monolayer. When it is forced into a monolayer, the blood spreads, and each channel (capillary tube) is then able to uptake blood.

This embodiment is well suited to identify multiple cell types that require disparate stains or other reagents. For example, parasites such as malaria may require a different stain than leukocytes. This also allows customized test strips for the different conditions of interest. For example, there may be an outbreak of a particular disease at a particular locale such as in a tropical region of Africa. In response, one can manufacture a test strip specifically for expected diseases which can imaged (and hence tested for) in distinct capillary tubes.

When manufacturing test strips having parallel capillary tubes, the manufacturing system is configured to place the tubes at particular locations where the computer vision algorithm will be expecting them (and therefore look for markers specific to that capillary). In certain embodiments, the base test strip will have etchings/openings/slits/perfectly clear regions where each capillary tube is placed. Otherwise, the capillary tubes need not be any different from the capillary tubes used in other embodiments. They can be machined and manufactured the same way. The stain or other reagent can be loaded into the capillary tube the same way as before as well. One end of the capillary tube may be dipped into a particular solution/stain and the stain will be taken up by the capillary tube, the alcohol/solvent will dry depositing the stain in the correct capillary tube.

The test strips may be provided in a kit with other components such as lancets and cleaning brush for inside the imager's test strip insertion slot.

Method and Apparatus for Generating Optical Images of Smears

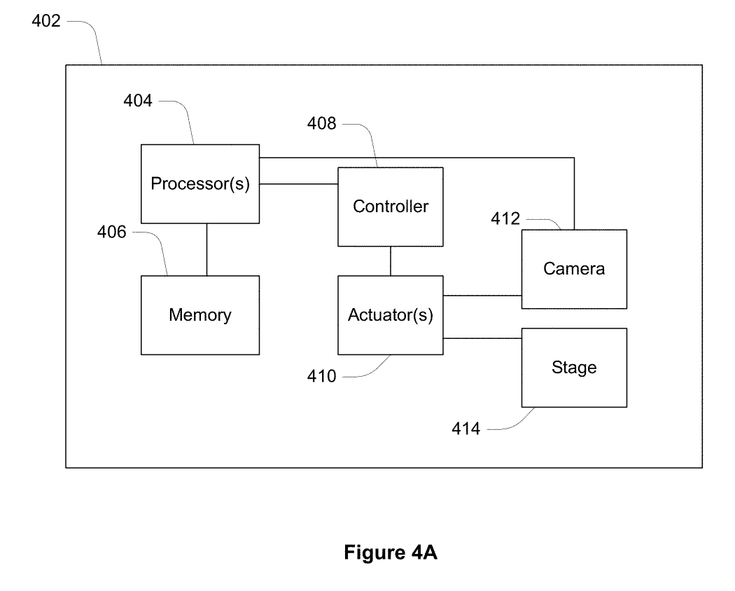

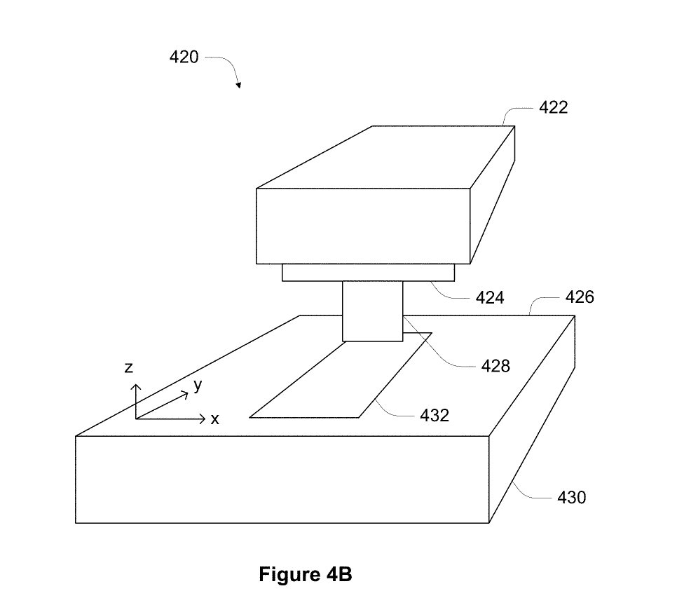

One aspect of the instant disclosure provides a system for automatically imaging a biological sample of a host organism. The images obtain by the system can be automatically analyzed to identify cellular artifacts, which can then be classified as one or more sample features of interest using a machine-learning classification model. FIG. 4A shows a diagram of such an imaging system. System 402 includes one or more processors 404 and memory that is connected to the processors 404. The processes 404 is communicatively connected to a camera 412. The processors are also communicatively connected to a controller 408. The controller 408 is connected to one or more actuators 410. The processors 404 are configured to send instructions to the controller 408, which based on instructions from the processors can send control signals to the one or more actuators 410.

In some implementations, the one or more actuators are coupled to the camera 412. In some implementations, the one or more actuators are coupled to a stage 414 for receiving a biological sample. In some implementations, the one or more actuators can move the camera 412 and/or the stage 414 in one, two, or three dimensions. In some implementations, the actuators 410 include a linear actuator. In some implementations, the actuators 410 include a rotary actuator. In some implementations, the actuators can be hydraulic actuators, pneumatic actuators, thermal actuators, magnetic actuators, or mechanical actuators, etc. In some implementations, the camera 412 includes a CMOS sensor and/or a CCD sensor.

FIG. 4B illustrates a schematic diagram of a system 420 for imaging a biological sample of a host organism. The system 420 includes a camera 428. As illustrated here, the camera 428 is positioned above the stage 430. The stage 430 includes an area 432 for receiving a biological sample. The biological sample can be a smear of the biological sample position on a transparent portion of a slide or other test strip. The system automatically moves the camera 428 and/or the stage 430 so that the camera 428 can capture one or more images of the biological sample without requiring a human operator to adjust the camera or the stage to change the relative positions of the camera 428 and the biological samples on the stage 430.

The system 420 includes one or more processors. In some implementations, the one or more processors are included in a housing 422 that is coupled to the camera 428 or another part of the system. In some implementations, the one or more processors may be implemented on a separate computer that is communicatively connected to the imaging system 420. In some implementations, the one or more processors of the system send instructions to control one or more actuators. In some implementations, one or more actuators are coupled to the camera 428. In some implementations, one or more actuators are coupled to the stage 430. The one or more actuators move the camera 428 and/or the stage 430 to change the relative positions between the image sensor of the camera and a biological sample positioned at an area 432 on the stage 430.

In some implementations, only the camera 428 is moved during image capturing. In some implementations, only the stage 430 is moved. In some implementations, both the camera 428 and the stage 430 are moved.

In some embodiments, the actuator 424 moves the camera 428 in a first dimension as indicated by the axis X that is perpendicular to the optical axis of the camera as indicated by the axis Z. In some implementations, the actuator 424 moves the camera 428 in a second dimension as indicated by the arrow Y that is perpendicular to both dimension X and axis Z. In some implementations, axis X and/or axis Y may deviate from a plane perpendicular to axis Z (the optical axis of the camera). In some implementations, the angle formed by the first dimension (axis X) and the optical axis of the camera (axis Z) is in a range between about 45° to 90°. Similarly, in some implementations, the angle formed between axis Y and axis Z is in the range between about 45° to 90°.

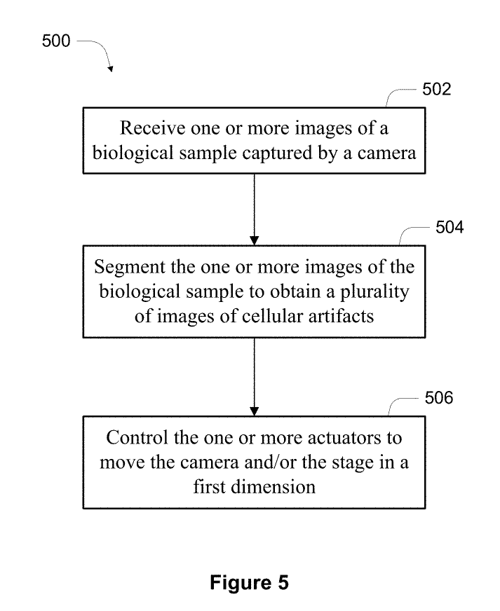

In some implementations, one or more processors of the system 420 are configured to control one or more actuators. In some implementations, the one or more processors of the system 420 are configured to perform operations in process 500 illustrated in a block diagram shown in FIG. 5. In the process 500, the one or more processors are configured to receive one or more images of a biological sample captured by the camera. See block 502. Moreover, the one or more processors are configured to segment the one or more images of the biological sample to obtain one or more images of sample features for producing cellular artifacts. See block 504. The segmentation in block 504 may involve one or more operations as further described hereinafter. Furthermore, the one or more processors of the system are configured to control the one or more actuators to move the camera and/or the stage in the first dimension as described above. See block 506. In some implementations the one or more processors are also configured to control the actuators to move the camera and/or the stage in a second dimension and/or the first dimension as described above. Such movements can automate the image capturing process without requiring a human operator to observe the image or adjust the position of the biological sample relative to the camera.

In some implementations, controlling the one or more actuator to move the camera and/or the stage in the first dimension includes: processing the one or more images of the sample features or cellular artifacts to obtain at least one measure of the one or more images of the sample features or cellular artifacts. In some implementations, the at least one measure may be a contrast value of the one or more images of the cellular artifact, the distribution of luminosity or chromatic values of the one or more images, a value of a linear component in the one or more images, a value of a curvilinear component in the image, etc.

In some implementations, the one or more processors of the system determine that the at least one measure of the one or more images of the sample feature or cellular artifact is in the first range, and control the one or more actuators to move the camera and/or the stage in a first direction in the first dimension. The movement of the first direction can be based on a determination that the at least one measure (e.g., a contrast value or one or more parameters of a luminosity distribution of the image) is in a first range. In some implementations, when the at least one measure is in a first range, the camera and/or the stage is moved in a first direction in the first dimension. However, when the at least one measure of the images is in a second range, the camera and/or the stage may be moved in a second direction different from the first direction in the first dimension. In some implementations, this control mechanism provides fast feedback during camera and/or stage movements to fine-tune the movements on the fly.

In some implementations, the camera and/or the station are configured to be moved in a first range that is likely to encompass a potentially relevant portion of the biological sample. In some implementations, a plurality of images is obtained when the camera moves along the range. The one or more processors process the plurality of images of the cellular artifacts to obtain a plurality of measures of the plurality of images. The one or more processors are configured to analyze the plurality of measures to determine a second range smaller than the first range in which to position the camera and/or the stage. The analysis of the plurality of images in effect provides a map of one or more relevant regions of the biological sample. Then the one or more processors control the one or more actuators to move the camera and/or the stage in a first dimension in the one or more relevant regions.

In some implementations, the one or more processors of the imaging system 420 are configured to change the focal length of the camera based on the data obtained from the one or more images of the cellular artifacts. This operation helps to bring the image into focus by adjusting the focal length of the optic instead of the relative position of the sample.

Example Cell Analysis System

In some implementations, a blood sample analysis system such as a white blood cell count system (or WBC System) is provided for use for diagnostic uses. As example, the system may provide a semi-quantitative determination of white blood cell (WBC) count in capillary or venous whole blood. In some implementations, the range of determinations can be divided into different levels. In some implementations, the levels and corresponding ranges are: Low (below 4,500 WBCs/μL), Normal (between 4,500 WBCs/μL and 10,000 WBCs/μL) and High (greater than 10,000 WBCs/μL). The WBC System may be used in clinical laboratories and for point of care settings.

The system of this example includes two principal parts: (1) an analyzer device and (2) test strips. In some implementations, a blood sample of approximately 1-10 μL (e.g., 4 μL) is drawn into the capillary tube by capillary action. A staining agent (e.g., methylene blue and cresyl violet) stains the white blood cells. An image is taken of the stained cells, which may be classified and/or counted by image analysis performed by the analyzer. In some implementations, the test strip includes a hemolysing agent (saponin) that lyses the red blood cells in the test strip, thereby allowing easy identification of white blood cells.

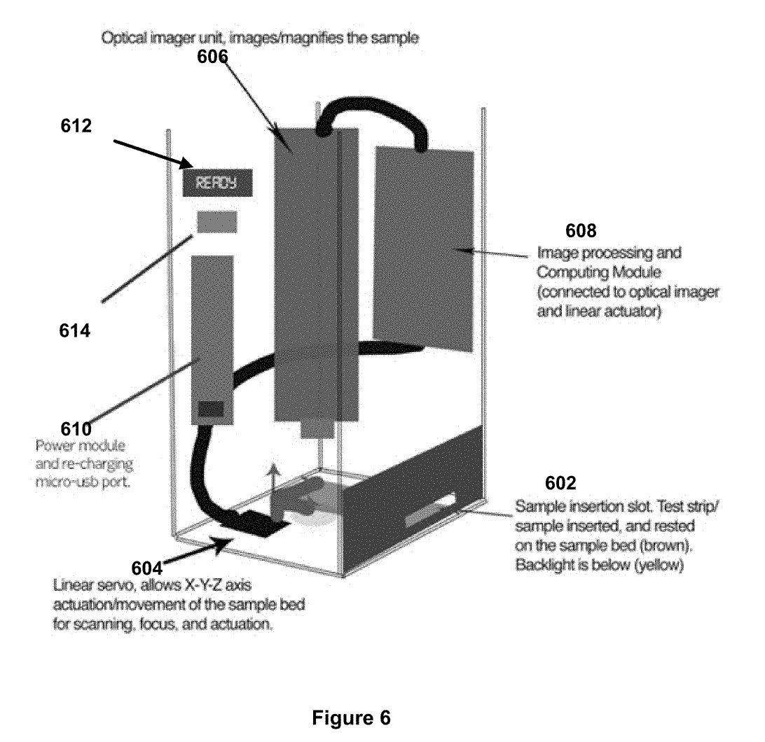

FIG. 6 illustrates components of an analyzer including a test strip holder 602, linear actuator 604, optical imager unit 606, image processing and computing module 608, power module 610, display 612, and button 614.

In operation, the test strip is inserted into test strip holder 602. The test strip is then moved into the correct measuring position by linear actuator 604, which adjusts the placement of the sample for optimal scanning and focus. Various linear actuators described elsewhere herein may be implemented in the analyzer, such as the system in FIG. 4A.

The optical imager unit 606 magnifies and images the sample on the test strip. Optical imager unit 606 transmits data to the image processing and computing module. Image processing and computing module 608 contains image processing software that analyzes the image to count white blood cells and/or directs the linear actuator to reposition the sample for optimized scanning and focus. Further details of the imaging analysis process are described hereinafter. Image processing and computing module 608 sends the final reading to an LED screen 6112 on the analyzer.

Table 1 provides technical specifications of an implementation of an example WBCAnalyzer.

TABLE 1
Technical Specifications of a WBC Analyzer

| | |
|---|---|
| Output | OLED screen interface and button |
| Power | Rechargeable lithium-ion 6 v, medical grade |
| | battery pack. It powers an image processing |
| | and computing module, a backlight module, an |
| | optical imager unit, and all remaining components |
| | of the system. |
| Physical | Cylindrical shape with dimensions: 26.7 cm |
| Characteristics | height × 8.9 cm diameter |
| | Weight: 455 g |
| Operating | 35-70 F., <90% non-condensing humidity |
| Environment | Allow the analyzer to reach room temperature |
| | before use. |
| Storage Environment | 35-70 F., <90% non-condensing humidity. |
| Hardware | Objective lens (10x) |
| | 5-megapixel digital CMOS image sensor |
| | Raspberry Pi Computing module with Broadcom |
| | BCM2847 SoC processor |
| Software | Linux Operating System |
| | Python, JAVA, Shell Script |

Training Machine Learning Models for Images of Biological Samples

Training Sets

Training a deep learning or other classification model employs a training set that includes a plurality of images having cells and/or other features of interest in samples. Collectively, such images may be viewed as a training set. The images of the training set include two or more different types of sample features associated with two or more conditions that are to be classified by the trained model. In various embodiments, the images have their features and/or conditions identified by a reliable source such as a trained morphologist. In certain embodiments, the sample features and/or conditions are classified by a classifier other than an experienced human morphologist. For example, the qualified classifier may be a reliable pre-existing classification model. Training methods in which the sample features and/or conditions are pre-identified and the identifications are used in training are termed supervised learning processes. Training methods in which the identities of sample features and/or conditions are not used in training are termed unsupervised learning processes. While both supervised and unsupervised learning may be employed with the disclosed processes and systems, most examples herein are provided in the context of supervised learning.

The images used in training should span the full range of conditions that the model will be capable of classifying. Typically, multiple different images, taken from different samples, are used for each condition. In certain embodiments, the training set includes images of least twenty samples having a particular cell type and/or condition to be classified. In certain embodiments, the training set includes images of least one hundred samples, or at least two hundred samples, having a particular cell type and/or condition to be classified. The total number of samples used for each cell type and/or condition may be chosen to ensure that the model is trained to a level of reliability required for application (e.g., the model correctly classifies to within 0.9 of the gold standard). Depending on the task, the training set may have about 500-80,000 images per set. In certain embodiments, blob identification/nucleation tagging tasks require about 500-1000 images. In certain embodiments, for entire body classification (e.g., detecting a cell independent of nucleation features) about 20,000 to 80,000 images may be required.

As an example, a training set was produced from CDC data and microscope imaging of Carolina Research smear samples. The training set included images of the sample types of Table 2.

TABLE 2
Sample Types of a Training

| Sample Type | N_Samples |
|---|---|
| Trypanosoma Cruzi | 253 |
| Trypanosoma Brucei | 248 |
| Drepanocytosis | 228 |
| Healthy Whole Blood | 282 |
| P. Falciparum | 237 |

As an example, using labeled versions of these images, a deep learning model was trained to identify Trypanosoma, Drepanocytosis (Sickle Cell), Plasmodium, healthy erythrocytes (Red Blood Cells), and healthy leukocytes (White Blood Cells).

A property of certain deep learning and other classification systems disclosed herein is the ability to classify a wide range of conditions and/or cell types, such as those relevant to various biological conditions. As an example, among the types of cells or other sample features that may be classified, and for which training set images may be provided, are cells of a host, parasites of the host, viruses that infect the host, non-parasite microbes that exists in the host (e.g., symbiotes), etc. However, in certain implementations, a relatively limited range of cell types is used for the training set. For example, only samples having white blood cells of various types (e.g., eosinophils, neutrophils, basophils, lymphocytes, and monocytes or a subcombination thereof) are used in the training set. Red blood cells and/or other extraneous features may or may not be removed from such training sets. But in general a relatively heterogenous training set is used. It may include both eukaryotes and prokaryotes, and/or it may include host and non-host cells, and/or it may include single celled and multi-cellular organisms.

Additionally, the cells of the host may be divided into various types such as erythrocytes and leukocytes. Additionally, leukocytes may be divided into, at least, monocytes, neutrophils, basophils, eosinophils, and lymphocytes. Lymphocytes may, in certain embodiments, be classified as any two or three of the following: B cells, T cells, and natural killer cells. Training sets for classification models that can correctly discriminate between such cell types include images of all these cell types. Further, host cells of a particular type may be divided between normal cells and abnormal cells such as cells exhibiting properties associated with a cancer or other neoplasm or cells infected with a virus.

Examples of parasites that can be present in images used in the training set include various ones of protozoans, fungi, bacteria, helminths, and even in some cases viruses. Depending on the classification application, examples from any one, two, or more of these parasite types may be employed. Specific types of parasite within any one or more of these parasite classes may be selected for the classification model. In one example, two or more protozoa are classified, and these optionally differ by their motility mode; e.g., flagellates, ciliates, and/or ameba. Specific examples of protozoa that may be classified include Plasmodium falciparum (malarial parasite), Plasmodium vivax, Leishmania spp., and Trypanosoma cruzi.

In various embodiments, the training set includes images that contain both (i) normal cells in the host and (ii) one or more of parasites of the host. As an example, the training set includes images that include each of red blood cells, white blood cells (sometimes of various types), and one or more parasitical entities such as fungi, protozoa, helminths, and bacteria. In certain embodiments, the training set images include those of both normal and abnormal host cells as well as one or more parasites. As an example, the training set includes normal erythrocytes and normal leukocytes, as well as a neoplastic host cell, and a protozoan or bacterial cell. In this example, the neoplastic cell may be, for example, a leukemia cell (e.g., an acute lymphocytic leukemia cell or an acute myeloid leukemia cell). In a further example, the training set may include both a protozoan cell and a bacterial cell. For example, the protozoan cell may include one or more examples from of the babesia genus, the cytauxzoon genus, and the plasmodium genus. As a further example, the bacteria cell may include one or more of an anaplasma bacterium and a mycoplasma bacterium. In certain embodiments, the training set images include those of erythrocytes, leukocytes, and platelets, as well as one or more parasites. In certain embodiments, the training set images include those of erythrocytes, leukocytes, and at least one undifferentiated blood cell (e.g., a blast cell or myeloblast cell), as well as one or more parasites. In certain embodiments, the training set images include those of erythrocytes, leukocytes, and at least non-blood cell (e.g., a sperm cell), as well as one or more parasites. In certain embodiments, the training set images include those of erythrocytes and two or more types of leukocytes (e.g., two or more selected from neutrophils, eosinophils, lymphocytes, monocytes, and basophils), as well as one or more parasites.

In one example, the training set includes each of the following:
Erythrocytes
At least one type of leukocyte
At least one type of non-blood cell
At least one type of undifferentiated or stem cell
At least one type of bacterium
At least one type or protozoa

In another example, the training set includes at least the following:
Erythrocytes—normal host cell (anucleated blood cell)
Leukocytes—normal host cell (general)
Neutrophils—normal host cell (specific type of WBC)
Lymphocytes—normal host cell (specific type of WBC)
Eosinophils—normal host cell (specific type of WBC)
Monocytes—normal host cell (specific type of WBC)
Basophils—normal host cell (specific type of WBC)
Platelets—normal host cell (anucleated blood cell)
Blast Cells—primitive undifferentiated blood cells—normal host cells
myeloblast cells—unipotent stem cell found in the bone marrow—normal host cell
Acute Myeloid Leukemia Cells—abnormal host cell
Acute Lymphocytic Leukemia Cells—abnormal host cell
Sperm—normal host cell (non blood)
Parasites of the Anaplasma genus—rickettsiales bacterium that infects host RBCs—gram negative
Parasites of the Babesia genus—protozoa that infects host RBCs
Parasites of the Cytauxzoon genus—protozoa that infects cats
Mycoplasma haemofelis—bacterium that infects cell membranes of host RBCs—gram positive
Plasmodium Falciparum—protozoa that is a species of malaria parasite; infects humans and produces malaria
Plasmodium vivax—protozoa that is a species of malaria parasite; infects humans and produces malaria
Plasmodium ovale—protozoa that is a species of malaria parasite (rarer than falc and vivax); infects humans and produces malaria
Plasmodium malariae—protozoa that is a species of malaria parasite; infects humans and produces malaria but less severe than falc and vivax

In some cases, the classifier may be trained to classify cells of different levels of maturity or different stages in their life cycles. For example, certain leukocytes such as neutrophils have an immature form known as band cells which may be identified by multiple unsegmented nuclei connected to the central region of the cell. The distance and connection structure between the peripheral lobes, with unsegmented nuclei, and the central region may indicate the level of maturity of the cells. An increase in band neutrophils typically means that the bone marrow has been signaled to release more leukocytes and/or increase production of leukocytes. Most often this is due to infection or inflammation in the body.

In addition to (or as an alternative to) images of cells of the host and parasites of the host, the training set may include images, representing various conditions that might not be directly correlated with particular types of host cells, parasites cells, microbe cells, and or viruses. Examples of features in an image that may represent such conditions include extracellular fluids of certain types, floating precipitates in extracellular fluids, lymph material, prions, conditions of plasma, absolute and relative numbers of different types of host cells, and the like. In certain embodiments, the color (hue or magnitude of the color signal) of the sample fluid may be used to infer information about the viscosity and/or in vivo conditions associated with the fluid (e.g., the size of a vessel or lumen from which the fluid originated).

Sources of Training Set Images

Some training set images may be taken from publicly available libraries such as those of the United States Center for Disease Control, e.g., the CDC public smear sets. Other images may be captured with the system that will be used to produce images in the field, i.e., the system that is used to image biological samples and provide the images to a deep learning model for classification. In some cases, the training set images are microscopy images labeled morphologically to establish a human gold standard.

The human gold standard labeling procedure includes collecting all or a portion of the samples of a given parasite, or other cell or condition to be classified, from a public repository (e.g., a CDC repository) or other source of imaged microscopy with appropriate label assigned. Pre-labeled images may be archived in a directory; unlabeled images may be manually labeled in accordance with morphology guidelines (e.g., CDC guidelines) for specific cellular artifact type. Human manual labeling is the current gold-standard for the range of parasites; any cell-type whose class label is still unclear (even after applying, e.g., CDC morphology guidelines) is set aside and may be sent to an expert morphologist for classification.

The set of images from which a training set is derived may include images that are left behind for validating deep learning models prepared using the training set. For example, a set of images may be divided into those that are used to train a deep learning model and those that are not used to train the model but are left behind to test and ultimately validate the model.

Training Methodology

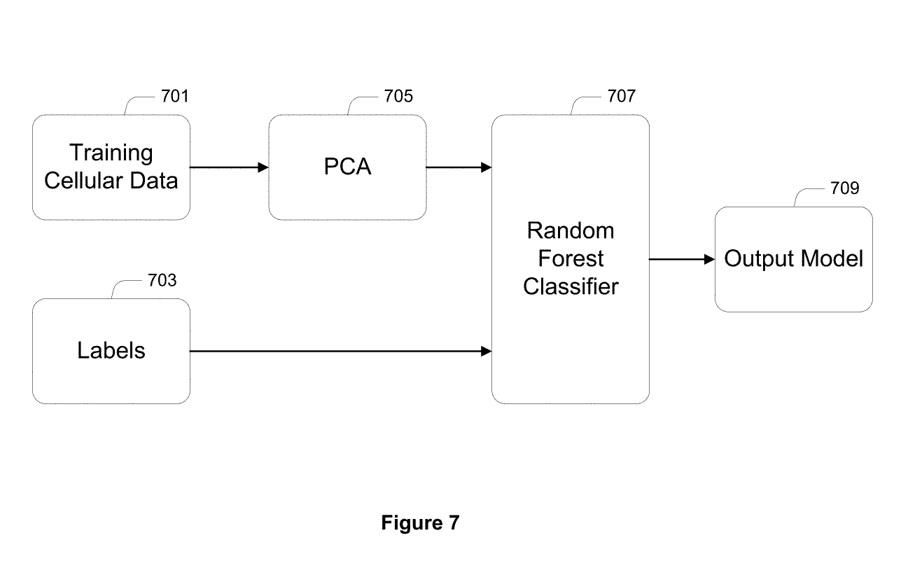

FIG. 7 illustrates an overview of training procedure of a classification model, according to an embodiment disclosed herein. Inputs to the training procedure are a training set of images 701 and labels 703 of cells or conditions shown in each of those images. In the depicted embodiment, multiple dimensions of data are identified in each of the images, and those dimensions are reduced using principal component analysis as depicted in a process block 705. In one example, the PCA block 705 reduces data contained in the training set images to no more than ten dimensions. While not shown in this figure, the training set images may be segmented prior to being provided to PCA block 705. The reduced dimensional output describing the individual images and the labels associated with those images are provided to a random forests model generator 707 that produces a random forests model 709, which is ready to classify biological samples. In certain embodiments, the data provided to the random forests model generator 707 is randomized. While FIG. 7 illustrates training of a random forests model, other forms of model may be generated such as neural network deep learning models as described elsewhere herein. Each sample image (labeled in the training data) is used to seed the random forests based on its assigned class label.

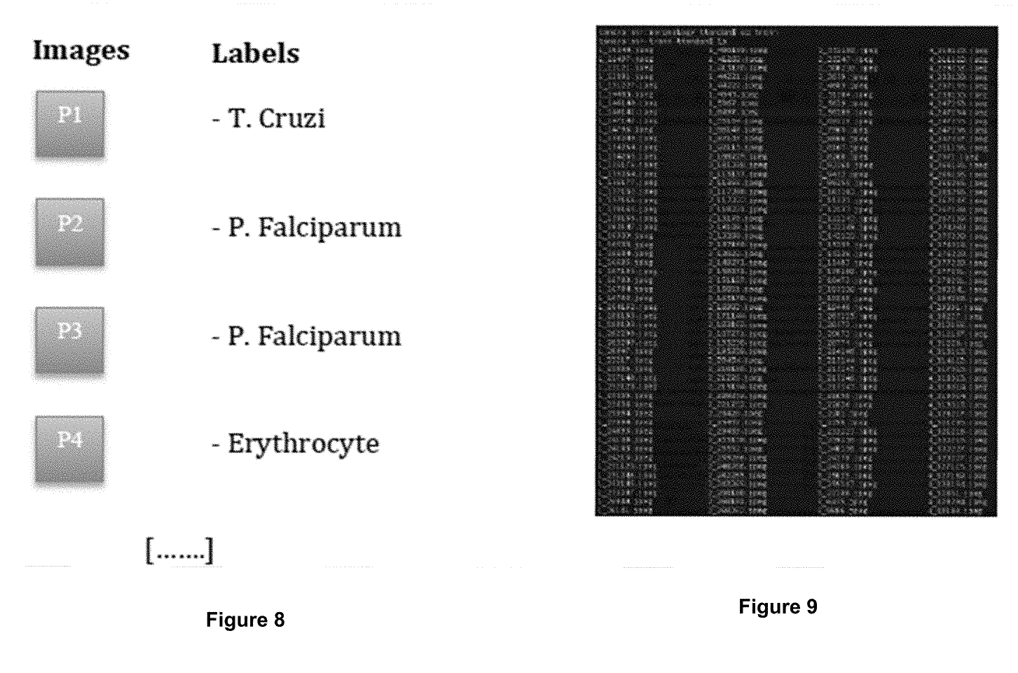

FIG. 8 illustrates a training directory structure, according to an embodiment. The training directory structure includes images and assigned labels (classes) for each sample image in training data. FIG. 9 illustrates a training directory with image jpeg shots used for training, according to an embodiment. As more fully described elsewhere herein, the model training extrapolates trends between the segmented pixel data and the labels they are assigned. In the field, the model applies these trends to identify cell types and/or conditions, allowing for, e.g., cell counts and parasite disease identification.

Segmentation of Images of Biological Samples

General Goals and Overview

Typically, the classification model receives a segmented image as input. The segmentation process identifies groups of contiguous pixels in an image that are selected because they might correspond to an image of a cell, a parasite, microbe, virus, or other sample feature that is to be classified by the model. Various segmentation techniques can be employed, many of which are known to those of skill in the art. These include Euclidean transformations, luminosity projection, adaptive thresholding, Otsu thresholding, elevation mapping, local maxima analysis, etc. Unless otherwise indicated, the methods and systems disclosed herein are not limited to any particular segmentation technique or combination of such techniques.

Through the segmentation process, the features identified are provided as a collection of pixels, which like all pixels in the image have associated magnitude values. These magnitude values may be monochromatic, (e.g., grayscale) or they may be chromatic such as red, green, and blue values. Additionally, the relative positions of the pixels with respect one another (or the overall positions with respect to the image) are denoted in the extracted feature. The collection of pixels identified as containing an image the sample feature, and typically a few pixels surrounding the sample feature, are provided to the classifying model. In many cases, the collections each collection of pixels identified through segmentation may be a separate cellular artifact. The classifying model acts on each cellular artifact and may classify it according to a type of feature, e.g., a type of host cell, a type of pathogen, a disease condition, etc.

Thresholding

In certain embodiments, the segmentation procedure involves removing background pixels from foreground pixels. As known to those of skill in the art, various techniques may be used for foreground/background thresholding. Such techniques preserve the foreground pixels for division into cellular artifacts. Examples include luminosity approaches, Otsu thresholding and the like.

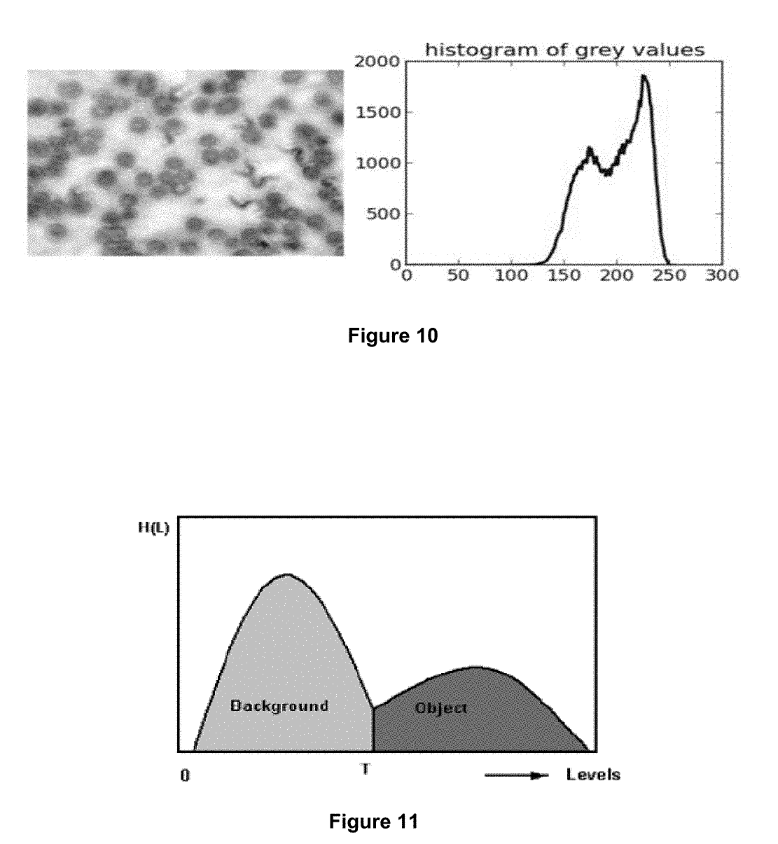

FIG. 10 illustrates a generated intensity map and a histogram of gray values taken from a biological sample image, according to an embodiment herein. In certain implementations, in a first stage of segmentation involves projection of an RBG image to a numpy intensity map (entirely grayscale). A luminosity approach may be employed to generate the intensity map as shown in equation 1.

L(rgb)={0.21 R+0.72 G+0.07 B} Eq. (1)

The colors are weighted accordingly to take into account human perception (higher sensitivity to green). The luminosity function generates the grayscale image clearly showing Trypanosoma parasites, along with the accompanying histogram indicating a clear foreground and background (indicated by the spikes in the graph).

FIG. 11 illustrates a bi-modal histogram using Otsu's method for threshold identification, according to an embodiment herein. Following the intensity mapping, there is still observable noise surrounding the image cells. Thresholding can identify and truncate this noise, leaving only artifacts of interest (foreground), for continued cellular analysis. This process is paralleled to the subconscious procedure that a human pathologist would conduct in distinguishing cells from background. FIG. 11 and equation (2) shows the generalized developed technique for Otsu histogram-based thresholding.

σ_{ω}²(t)=ω₁(t)σ₁²(t)+ω₂(t)σ₂²(t)

σ_{b}²(t)=σ²−σ_{ω}²(t)=ω₁(t)ω₂(t)[μ₁(t)−μ₂(t)]² Eq. (2)

Otsu clusters the binary classes (foreground and background) by minimizing intra-class variance, which is shown to be the same as maximizing inter-class variance. Thus, the optimal image threshold can be found, and, the intensity map may undergo foreground extraction. The Otsu method searches for the threshold that minimizes the intraclass variance defined as a weighted sum of variances of the two classes. The intraclass variance σ_{ω}²(t) are weighted by ω₁(t) and ω₂(t), and the weights are the probabilities of the two classes separated by the threshold t.

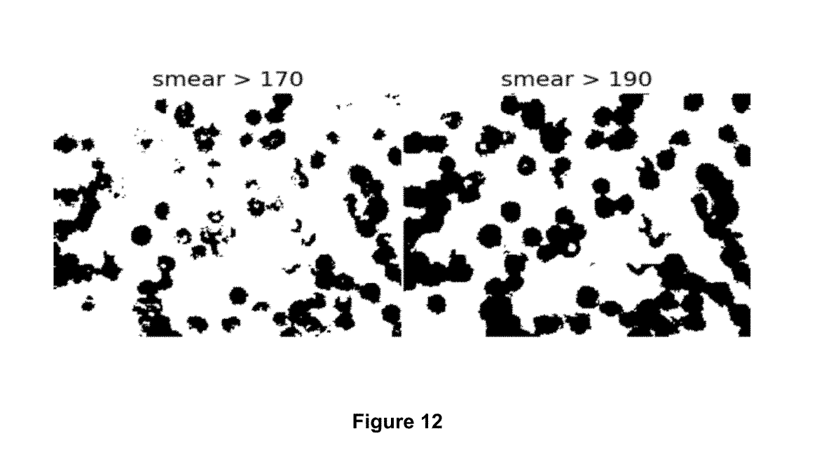

FIG. 12 illustrates Otsu derived threshold of pixel darkness for smear image, according to an embodiment herein. The 12 highlights the Otsu threshold transformation, with t=190 (right image) being the calculated optimum threshold for the particular smear. A lower threshold of t=170 (left image) is provided to highlight less than optimal threshold value for binary foreground classification. The threshold values are measured by the gray values of the image pixels as shown in FIG. 10. The thresholding method converts the foreground values and background gray values into two binary values.

Some images will include regions that are overall darker than other parts of the image due to changing lighting conditions in the image, e.g. those occurring as a result of a strong illumination gradient or shadows. As a consequence, the local values of the background may vary across regions of an image. A version of thresholding can accommodate this possibility by doing thresholding in a localized fashion, e.g., by dividing the image into regions, either a priori or based on detected shading regions.

Two approaches to finding a variable threshold are (i) the Chow and Kaneko approach and (ii) local thresholding. The assumption behind both methods is that smaller image regions are more likely to have approximately uniform illumination, thus being more suitable for thresholding. Chow and Kaneko divide an image into an array of overlapping subimages and then find the optimum threshold for each subimage by investigating its histogram. The threshold for each single pixel may be found by interpolating the results of the subimages. An alternative approach to finding the local threshold is to statistically examine the intensity values of the local neighborhood of each pixel. The statistic which is most appropriate depends largely on the input image. In any of the approaches, various portions of the image that are believed to possibly belong to different shading types are separately thresholded. In this way, the problem of using the same threshold for the entire image, which might remove relevant features such as those corresponding to cells or parasites in the shaded region of the image, is avoided.

Identifying Cellular Artifacts

When foreground-background discrimination is complete, the segmentation process transforms the foreground pixels into constituent cellular artifacts for training or classification. The process can be analogized to the procedure undertaken by a pathologist in analyzing each cell independently, differentiating it from surrounding cells.

In certain embodiments, the segmentation process employs a gradient technique to identify cellular artifact edges. Such techniques identify regions of an image where over a relatively short distance, pixel magnitudes transition abruptly from darker to lighter.

In certain embodiments, a segmentation process employs a distance transformation that topographically defines cellular artifacts in the image in context of boundary pixels. Pixels of an image obtained from thresholding include only binary values. The distance transformation converts the pixel values to gradient values based on the pixels' distance to a boundary obtained by foreground-background thresholding. Such transformation identifies ‘peaks’ and ‘valleys’ in the graph to define a cellular artifact. In some implementations, a distance to the nearest boundary (foreground-background boundary) is calculated by means of a Euclidean Distance Generalized Function given by equation (3), and is derived for the intensity value of the given pixel region.

$$\begin{matrix}d ( p , q ) = d ( q , p ) = \sqrt{{( {q}_{1} - {p}_{1} )}^{2} + {( {q}_{2} - {p}_{2} )}^{2} + … + {( {q}_{n} - {p}_{n} )}^{2}} \\ = \sqrt{{\sum }_{i = 1}^{n} {( {q}_{i} - {p}_{i} )}^{2}}\end{matrix} . \\ ‖ p ‖ = \sqrt{{p}_{1}^{2} + {p}_{2}^{2} + … + {p}_{n}^{2}} = \sqrt{p \cdot p} \qquad Eq . ( 3 )$$

The expression uses p and q as coordinate values. The distance transformation utilizes the threshold intensity map to define the topographical region of possible cells or other sample features in the image. The Euclidean technique re-formats the intensity plot based on the boundary location, hence successfully defining the intensity of each pixel in a cellular artifact as a function of its enclosure by the blob. This transformation allows for blob analysis by defining object peaks, or locations most consumed by the surrounding pixels as local maxima. The Euclid space reformats the two dimensional pixel array in accordance to distance between pixel_n and the background foreground boundary; it does not actually splice the two into segmented images. The intensity topography generated by the Euclid function can then be plotted in a three dimensional space to characterize cell boundaries, and identify regions of segmentation and body centers.

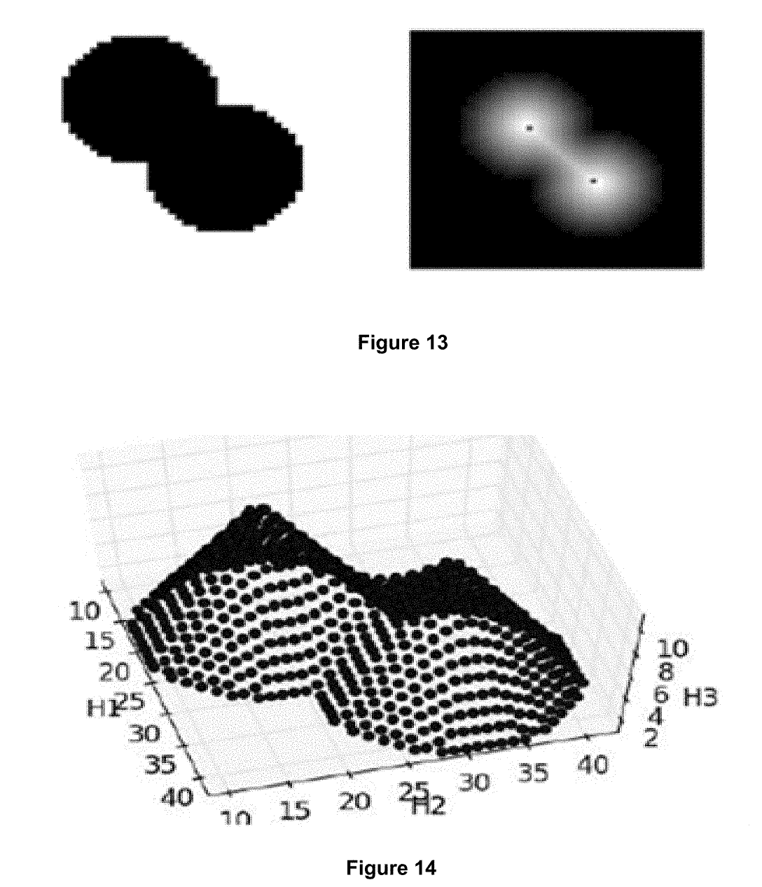

FIG. 13 illustrates a simulated cell body using Euclidean Distance Transformation, according to an embodiment as disclosed herein. The demarking points near the centers of the cells in the FIG. 13 are calculated local maxima based on multivariate numerical calculus analysis.

FIG. 14 is a graph showing the surface intensity of simulated cell body, according to an embodiment as disclosed herein. As depicted in the FIG. 14, the local maxima will indicate artifact body centers, leading to a location for segmentation.

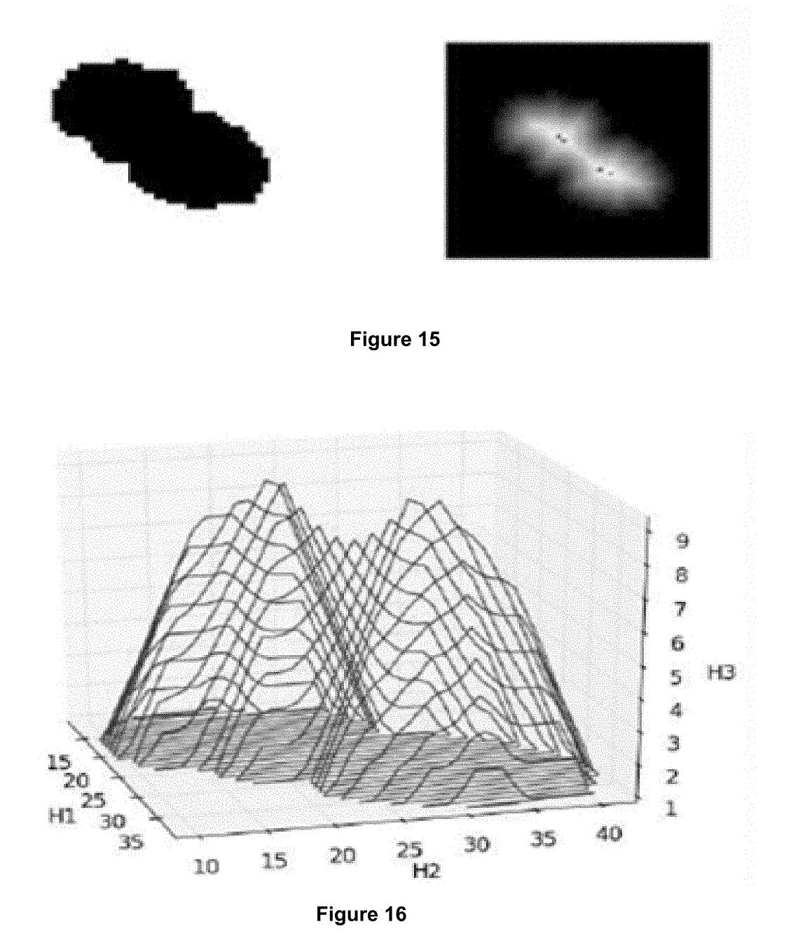

FIG. 15 illustrates a simulated RBC cell sample using Euclidean Distance Transformation, according to an embodiment as disclosed herein. The demarking points near the centers of the cells in the FIG. 15 are calculated local maxima based on multivariate numerical calculus analysis.

FIG. 16 is a graph showing the intensity plot of a simulated red blood cell, according to an embodiment herein. As depicted in the FIG. 16, the local maxima will indicate artifact body centers, leading to a location for segmentation.

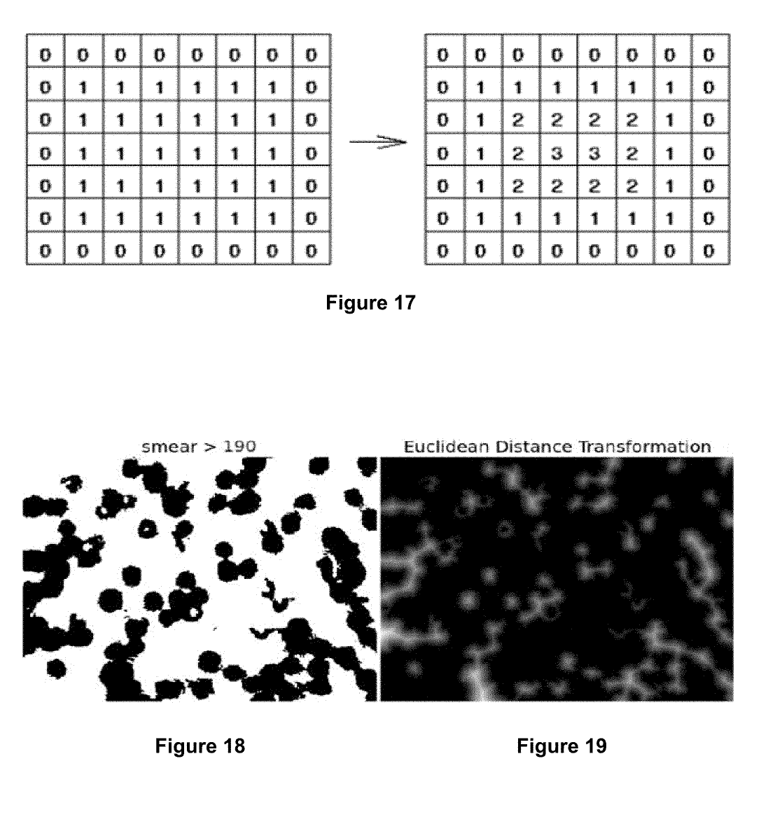

FIG. 17 illustrates a simple matrix Euclidean distance transformation for n dimensional space, according to an embodiment herein. FIG. 17 illustrates a simple matrix transformation example by using the Euclidean Transformation for intensity mapping.

FIG. 18 illustrates Otsu derived threshold for smear image, according to an embodiment herein. The FIG. 18 highlights the Otsu threshold transformation, with 190 being the calculated optimum threshold for the particular smear.

FIG. 19 illustrates the Euclidean distance transformation of Otsu derived threshold for smear image of FIG. 18, according to an embodiment aherein. The threshold smear is now newly mapped through this transformation, and the generated numpy array is passed to multivariate maxima identification.

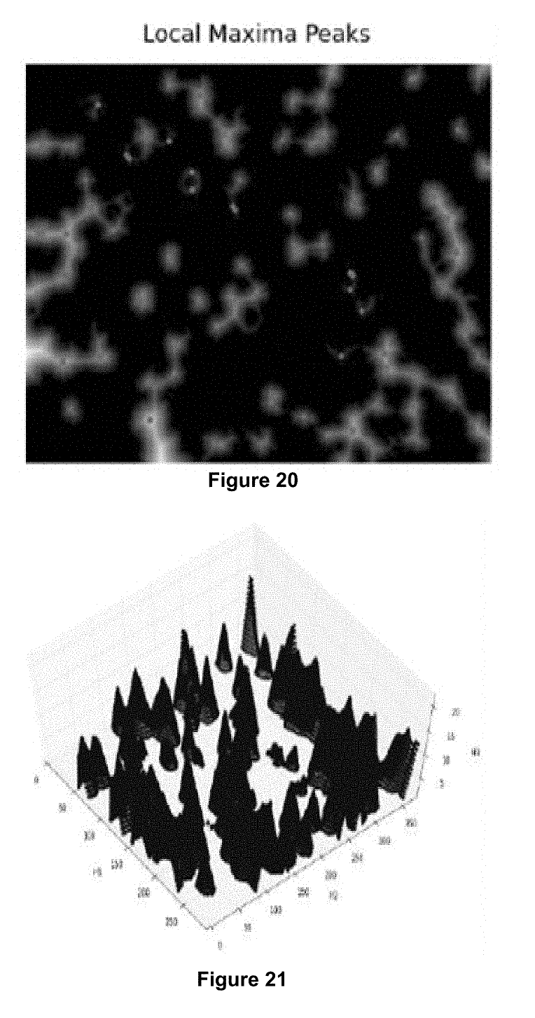

FIG. 20 illustrates the local maxima peaks in the two-dimensional numpy array, according to an embodiment herein. These peaks are used as the coordinates for segmentation, and define splicing rectangles for extracting cell bodies from the smear shot.

FIG. 21 illustrates a full smear maxima surface plot, according to an embodiment herein. Given the Euclidean peak region identifications, the image is then spliced based on the derived artifact dimensions from Sobel filtering elevation map generation given by equation 4. The Elevation map technique uses a Sobel operator to approximate the size of each artifact and conduct the cell extraction accordingly.

$${G}_{x} = [ \begin{matrix}- 1 & 0 & + 1 \\ - 2 & 0 & + 2 \\ - 1 & 0 & + 1\end{matrix} ] * A and {G}_{y} = [ \begin{matrix}+ 1 & + 2 & + 1 \\ 0 & 0 & 0 \\ - 1 & - 2 & - 1\end{matrix} ] * A \qquad Eq . ( 4 )$$

The Sobel Operator (Sobel Filter) is used to recreate processing image with highlighted prominence on edges. This creates an elevation map of the image that is combined with the Euclidean Transformation to segment and splice the cells.

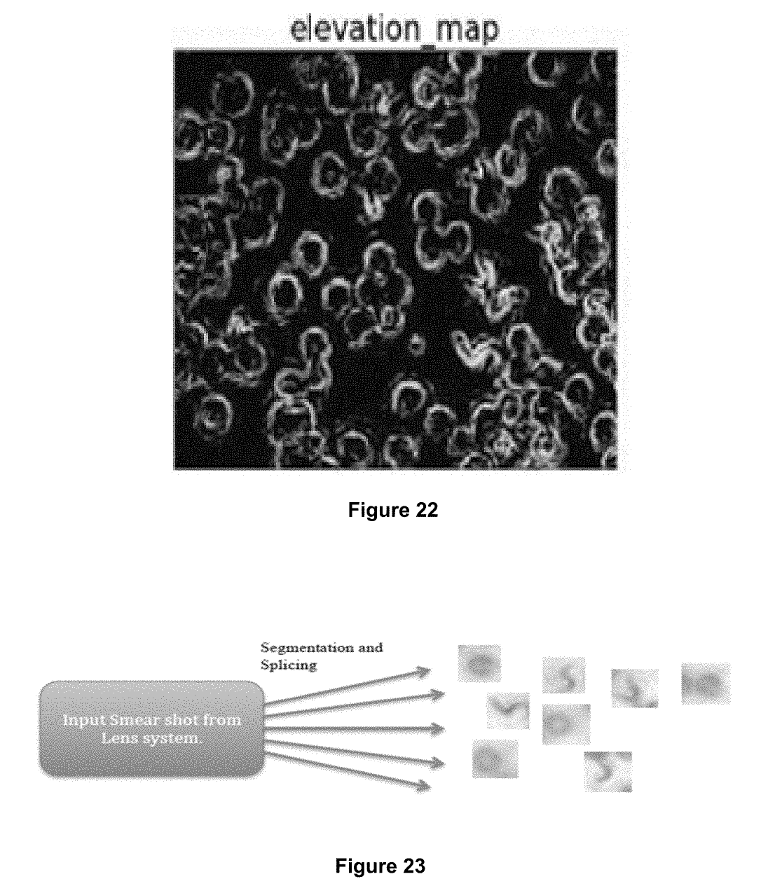

FIG. 22 illustrates a generated elevation map for a blood smear, according to an embodiment as disclosed herein. FIG. 22 shows the generated elevation map for a blood smear with the Sobel edges highlighted.

The spliced image is generated through the numpy sub array function passing the Euclidean and Sobel rectangular values as parameters, resulting in a dataset of segmented cells from the original smear image shot. The coordinates extracted from the Euclidean distance transformation and local maxima calculation are applied back to the original colored image to make the rectangular segmentation of cells on the original. The cells are then normalized to a 50×50 jpeg shot for identification. The segmentation procedure may be independent of any later classification—regardless of cell type or morphology; the splicing procedure will extract constituent cellular artifacts. Thus, this process automates the procedure taken by a trained pathologist when examining a smear field to distinguish between cells, and initiates the process for the actual morphology and cell identification.

FIG. 23 illustrates segmentation and splicing, according to an embodiment as disclosed herein. As depicted in FIG. 23, the segmented cellular artifacts are generated by using the generated Euclidean transformation to mimic the map on the original input image and generate the separate segment images.

Classifying Cellular Artifacts from Images Using Machine Learning Models.

Machine Learning Models and Classifiers Generally

Many types of machine learning models may be employed in implementations of this disclosure. In general, such models take as inputs cellular artifacts extracted from an image of a biological sample, and, with little or no additional preprocessing, they classify individual cellular artifacts as particular cell types, parasites, health conditions, etc. without further intervention. Typically, the inputs need not be categorized according to their morphological or other features for the machine learning model to classify them.

In the following description, two primary implementations of machine learning model will be presented: a convolutional neural network and a randomized Principal Component Analysis (PCA) random forests model. However, other forms machine learning model may be employed in the context of this disclosure. A random forests model has is relatively easy to generate from training set, and may employ relatively fewer training set members. A convolutional neural network may be more time-consuming and computationally expensive to generate from training set, but it tends to good at accurately classifying cellular artifacts.

Typically, whenever a parameter of the processing system is changed, the deep learning model is retrained. Examples of changed parameters include sample (e.g., blood) acquisition and processing, sample smearing, image acquisition components, etc. Therefore, when the system is undergoing relatively frequent modifications, retraining via a random forests model may be an appropriate paradigm. In other instances when the system is relatively static, retraining via the convolutional neural network may be appropriate. Due to the machine learning based nature of the classification techniques, it is possible to upload training samples of, e.g., dozens of other parasite smears, and immediately have the model ready to identify new cell types and/or conditions.

As explained, a property of certain machine learning systems disclosed herein is the ability to classify a wide range of conditions and/or cell types, such as those relevant to various biological conditions. As an example, among the types of cells or other sample features that may be classified are cells of a host and parasites of the host. Additionally, the cells of the host may be divided into various types such as erythrocytes and leukocytes. Further, host cells of a particular type may be divided between normal cells and abnormal cells such as cells exhibiting properties associated with a cancer or other neoplasm or cells infected with a virus. Examples of host blood cells that can be classified include anucleated red blood cells, nucleated red blood cells, leukocytes of various types including lymphocytes, neutrophils, eosinophils, macrophages, basophils, and the like. Examples of parasites that can be present in images and successfully classified include bacteria, fungi, helminths, protozoa, and viruses. In various embodiments, the classifier can classify both (i) normal cells in the host and (ii) one or more of parasites of the host, including microbes that can reside in the host, and/or viruses that can infect the host. As an example, the classifier can classify each of erythrocytes, leukocytes, and one or more parasites (e.g., Plasmodium falciparum).

In some embodiments, a machine learning classification model can accurately classify at least one prokaryote organism and at least one eukaryote cell type, which may be a parasite and/or a host cell. In some embodiments, a machine learning classification model can accurately classify at least two different protozoa that employ different modes of movement; e.g., ciliate, flagellate, and amoeboid movement. In some embodiments, a machine learning classification model can accurately classify at least normal and abnormal host cells. Examples of abnormal host cells include neoplastic cells such as certain cancer cells, dysplastic cells, and metaplastic cells. In some embodiments, a machine learning classification model can accurately classify at least two or more sub-types of a cell. As an example, a machine learning classification model can accurately classify leukocytes into two or more of the following sub-types: eosinophils, neutrophils, basophils, monocytes, and lymphocytes. Some models can accurately classify all five sub-types. In another example, a model can accurately classify lymphocytes into T cells, B cells, and natural killer cells. In some embodiments, a machine learning classification model can accurately classify at least two or more levels of maturity or stages in a life cycle for a host cell or parasite. As an example, a model can accurately classify a mature neutrophil and a band neutrophil. In each of the these embodiments, a single classifier can accurately discriminate between these cell types in any sample. The classifier can discriminate between these cell types in a single image from a single sample. It can also discriminate between these cell types across multiple samples and multiple images.

In various embodiments, a machine learning classification model can accurately classify both (i) normal cells in the host and (ii) one or more of parasites of the host. As an example, such a model can accurately classify each of red blood cells, white blood cells (sometimes of various types), and one or more parasitical entities such as fungi, protozoa, helminths, and bacteria. In certain embodiments, such model can accurately classify both normal and abnormal host cells as well as one or more parasites. As an example, the model can accurately classify normal erythrocytes and normal leukocytes, as well as a neoplastic host cell, and a protozoan and/or bacterial cell. In this example, the neoplastic cell may be, for example, a leukemia cell (e.g., an acute lymphocytic leukemia cell or an acute myeloid leukemia cell). In a further example, the model can accurately classify both a protozoan cell and a bacterial cell. For example, the protozoan cell may include one or more examples from of the babesia genus, the cytauxzoon genus, and the plasmodium genus. As a further example, the bacteria cell may include one or more of an anaplasma bacterium and a mycoplasma bacterium. In certain embodiments, the model can accurately classify erythrocytes, leukocytes, and platelets, as well as one or more parasites. In certain embodiments, the model can accurately classify erythrocytes, leukocytes, and at least one undifferentiated blood cell (e.g., a blast cell or myeloblast cell), as well as one or more parasites. In certain embodiments, the model can accurately classify erythrocytes, leukocytes, and at least non-blood cell (e.g., a sperm cell), as well as one or more parasites. In certain embodiments, the model can accurately classify erythrocytes and two or more types of leukocytes (e.g., two or more selected from neutrophils, eosinophils, lymphocytes, monocytes, and basophils), as well as one or more parasites.

In one example, the model can accurately classify each of the following:

Erythrocytes

At least one type of leukocyte

At least one type of non-blood cell

At least one type of undifferentiated or stem cell

At least one type of bacterium

At least one type or protozoa

In another example, the model can classify at least the following:
Erythrocytes—normal host cell (anucleated blood cell)
Leukocytes—normal host cell (general)
Neutrophils—normal host cell (specific type of WBC)
Lymphocytes—normal host cell (specific type of WBC)
Eosinophils—normal host cell (specific type of WBC)
Monocytes—normal host cell (specific type of WBC)
Basophils—normal host cell (specific type of WBC)
Platelets—normal host cell (anucleated blood cell)
Blast Cells—primitive undifferentiated blood cells—normal host cells
Myeloblast cells—unipotent stem cell found in the bone marrow—normal host cell
Acute Myeloid Leukemia Cells—abnormal host cell
Acute Lymphocytic Leukemia Cells—abnormal host cell
Sperm—normal host cell (non blood)
Parasites of the Anaplasma genus—rickettsiales bacterium that infects host RBCs—gram negative
Parasites of the Babesia genus—protozoa that infects host RBCs
Parasites of the Cytauxzoon genus—protozoa that infects cats
Mycoplasma haemofelis—bacterium that infects cell membranes of host RBCs—gram positive
Plasmodium Falciparum—protozoa that is a species of malaria parasite; infects humans and produces malaria
Plasmodium vivax—protozoa that is a species of malaria parasite; infects humans and produces malaria
Plasmodium ovale—protozoa that is a species of malaria parasite (rarer than falc and vivax); infects humans and produces malaria
Plasmodium malariae—protozoa that is a species of malaria parasite; infects humans and produces malaria but less severe than falc and vivax

In some cases, the classifier may be trained to classify cells of different levels of maturity or different stages in their life cycles. For example, certain leukocytes such as neutrophils have an immature form known as band cells which may be identified by multiple unsegmented nuclei connected to the central region of the cell. The distance and connection structure between the peripheral lobes, with unsegmented nuclei, and the central region may indicate the level of maturity of the cells. An increase in band neutrophils typically means that the bone marrow has been signaled to release more leukocytes and/or increase production of leukocytes. Most often this is due to infection or inflammation in the body.

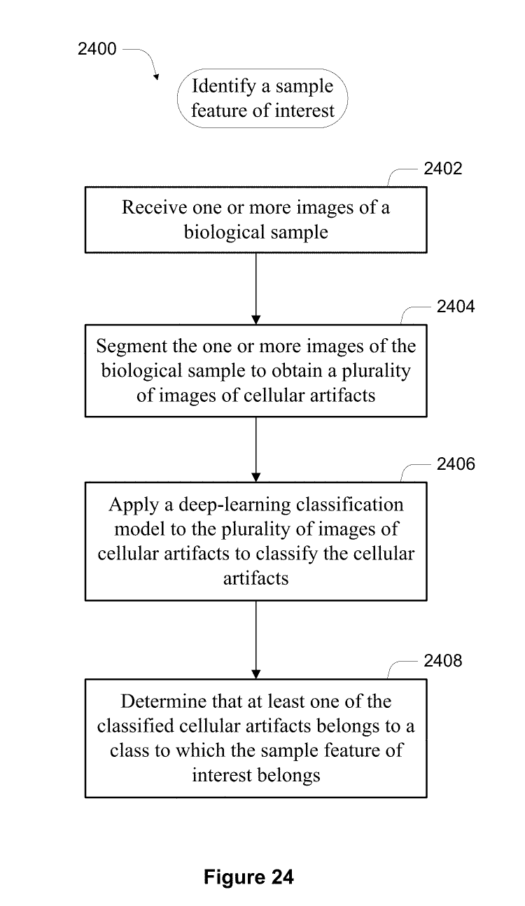

Certain aspects of the disclosure provide a system and method for identifying a sample feature of interest in a biological sample of a host organism. In some implementations, the sample feature of interest is associated with a disease. The system includes a camera configured to capture one or more images of the biological sample and one or more processors communicatively connected to the camera. In some implementations, the system includes the imaging system as illustrated in FIG. 4A and FIG. 4B. In some implementations, the one or more processors of the system are configured to perform a method 2400 for identifying a sample feature of interest as illustrated in FIG. 24. In some implementations, the one or more processors of the system are configured to receive the one or more images of the biological sample captured by the camera. See block 2402. The one or more processors are further configured to segment the one or more images of the biological sample to obtain a plurality of images of cellular artifacts. See block 2404.

In some implementations, the segmentation operation includes converting the one or more images of the biological sample from color images to grayscale images. Various methods may be used to convert the one on one or more images from color images to grayscale images. For example, a method for the conversion is further described elsewhere herein. In some implementations, the grayscale images are further converted to binary images using Otsu thresholding method as further described elsewhere herein.

In some implementations, the binary images are transformed using a using a Euclidean distance transformation method as further described elsewhere herein. In some implementations, the segmentation further involves identifying local minima of pixel values obtained from the Euclidean distance transformation. The local minima of pixel values indicate central locations of potential cellular artifacts. In some implementations the segmentation operation also involves applying a Sobel filter to the one or more images of the biological sample. In some implementations, the gray scale images are used. Data obtained through the Sobel filter accentuate edges of potential cellular artifacts.

In some implementations, segmentation further involves splicing the one or more images of the biological sample using the local maxima and data obtained from applying the Sobel filter, thereby obtaining a plurality of images of the cellular artifacts. In some applications, each spliced image includes a cellular artifact. In some implementations, the splicing operation is performed on color images of the biological sample, thereby obtaining a plurality of images of the cellular artifacts in color. In other implementations, gray scale images are spliced and used for further classification analysis.

In some implementations, each of the plurality of images of the cellular artifacts is provided to a machine-learning classification model to classify the cellular artifacts. See block 2406. In some implementations, the machine-learning classification model includes a neural network model. In some implementations, the neural network model includes a convolutional neural network model. In some implementations, the machine-learning classification model includes a principal component analysis and a Random Forests classifier. In some implementations, the method 2400 further involves determining that at least one of the classified cellular artifacts belongs to a class to which to a sample feature of interest belongs. See block 2408.

In some implementations where the machine-learning classification model includes principal component analysis and a random forests classifier, each of the plurality of images of the cellular artifacts is standardized and converted into, e.g., a 50×50 matrix, each cell of the matrix being based on a plurality of image pixels corresponding to the cell. This conversion helps to reduce the total amount of data to be analyzed. Different matrix sizes can be used depending on the desired computational speed and accuracy.

In various embodiments, the classifier includes two or more modules in addition to a segmentation module. For example, images of individual cellular artifacts may be provided by the segmentation module to two or more machine learning modules, each having its own classification characteristics. In certain embodiments, machine learning modules are arranged serially or pipelined. In such embodiments, a first machine learning module receives individual cellular artifacts and classifies them coarsely. A second machine learning module receives some or all of the coarsely classified cellular artifacts and classifies them more finely.

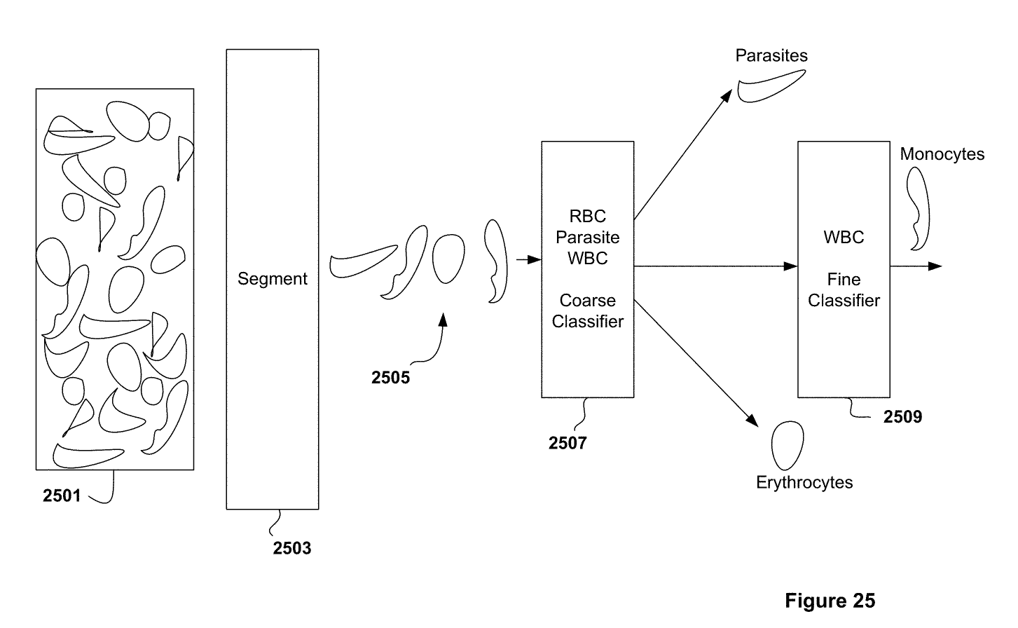

FIG. 25 illustrates such an example. As shown, a sample image 2501 is provided to a segmentation stage 2503, which outputs many multi-pixel cellular artifacts 2505. These are input to a first machine learning model 2507, which can coarsely classify cellular artifacts, separately, 2505 into, e.g., erythrocytes, leukocytes, and pathogens, each of which is counted, compared, and/or otherwise used to characterize the sample. In the depicted embodiment, cellular artifacts classified as leukocytes are input to a second machine learning model 2509, which classifies the individual leukocytes as lymphocytes, neutrophils, basophils, eosinophils, and monocytes. In some embodiments, the first machine learning model 2507 is a random forest model, and the second machine learning model 2509 is a deep learning neural network.

Random Forests Model

In some implementations the machine-learning classification model (or machine-learning classifier) uses a random forests method for classification. This machine-learning classification model may be trained in two stages. The first stage involves dimensionality reduction, and the second involves training a random forest model using data in reduced dimensions. The dimensionality reduction process is, in one implementation, a randomized Principal Component Analysis (PCA), in which some of the cellular artifacts extracted from training set images are randomly selected and then subject to PCA to extract, for example, ten principal components. As an example, the data feeding in to this system, which data represents cellular artifacts, may be standardized to have 50×50 pixel regions, which in theory represent 2500 dimensions. Through PCA or other dimensionality reduction procedure, these hundreds of dimensions can be reduced to, for example ten dimensions. Data of the ten dimensions can then be used to train a random forest of classification trees. By the same approach, sample data acquired in the field can be segmented to cellular artifacts, which are reduced to, e.g., the ten dimensions and then provided to a trained random forest to classify the sample data. When the model is actually executed in the field, any data processed, which data is typically going to be include cellular artifacts having, for example, 50 pixel by 50 pixel regions, is subject to the same dimensionality reduction that was employed in the randomly selected cellular artifacts used to train the model.

The random forest of classification trees are generated and then tested for their predictive capabilities. In some implementations, those trees that are weak predictors are removed, while those that are strong predictors are preserved to form the random forest. Each of the classification trees in the random forest has various nodes and branches, with each node performing decision operations on the dimensionally reduced data representing the cellular artifacts that are input the model.

The final version of the model, which contains multiple classification trees of the random forest model, classifies a cellular artifact by feeding it to each of the many classification trees and taking the outputs of each of these classification trees and combining them (e.g., by averaging) to make the final call for classification.

As mentioned, the reduced data of the plurality of images of the cellular artifacts may undergo dimensional reduction using, e.g., PCA. In some implementations, the principal component analysis includes randomized principal component analysis. In some implementations, about twenty principle components are obtained. In some implementations, about ten principal components are obtained from the PCA. In some implementations, the obtained principal components are provided to a random forests classifier to classify the cellular artifacts.

In some implementations, randomized PCA generates a ten dimensional feature vector from each image in the training set. Every element in the training set is represented by this multi-dimensional vector, and fed into the random forests module to correlate between the label and the features. By regressing between these feature vectors and the assigned cell-type class label, the model attempts to identify trends in the pixel data and the cell type. Random forests selects for trees optimizing on information gain in terms of accuracy in predicting cell type label. Thus, after being trained, given an unseen segmented image sample, the model predicts the cell type—using the classification model to identify parasite presence and cell count based on the training set.

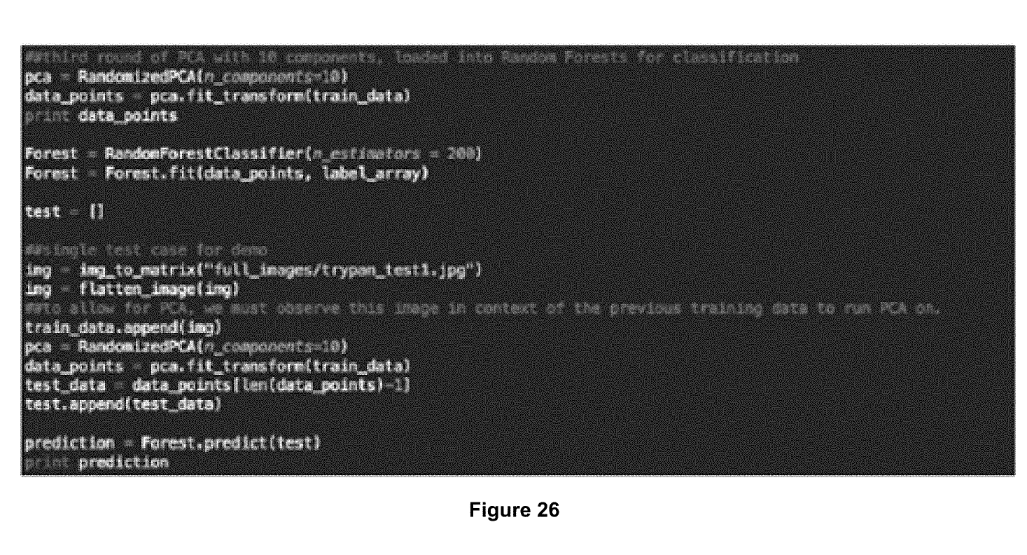

FIG. 26 illustrates the code snippet of high-level randomized PCA initializing, Forest initializing, training (fitting), and predicting on unseen test data sample, according to an embodiment as disclosed herein. The test data PCA is done in context of the training, to determine the Eigen vector projections.

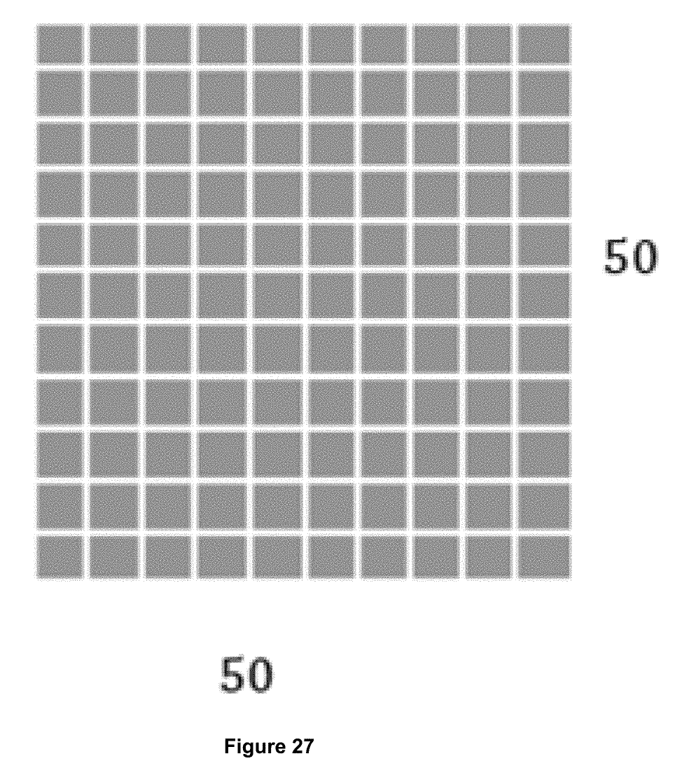

FIG. 27 illustrates the data segments being normalized to 50×50 jpeg images, according to an embodiment as disclosed herein. In model training, the raw pixels become features in analysis, however, given the incredibly high dimensionality of this data, it is unfeasible to train an entire classifier. As depicted in the FIG. 22, the data segments—being normalized to 50 by 50 jpeg images—would each contain 2500 features leading to potential model over fitting, and unworkable training times. Hence, the dimensionality reduction through PCA for lower dimensional data representations is conducted. The PCA Function is given by

{f1, . . . f2499, f2500} [symbol] {f1, f2, f3, f4, f5 . . . f9, f10}

The full model training procedure with PCA analysis and random forest data fitting requires, e.g., between 30 minutes to 1 hour based on the size of the training set. The outputted classifier (Forest) is then serialized, saving the grown tree states as .pickle for later classification and analysis. The training procedure is only conducted once per domain set, and is then scalable to all test data within the same domain. Predictions are outputted per image in CSV structure with the image ID and class label attached. In the FIG. 26; 200 estimators (trees) are grown with the data. Each estimator receives a randomized subset of the original data and splits of at randomized feature nodes to make a prediction. The stochastic nature of the forest tends to prevent overfitting on low-dimensional datasets, however the high dimensionality of image-based spaces exponentially increases training times. Thus, the lower dimensionality of the PCA application set alleviates this issue, and lowers training times. ANNs (Artificial Neural Networks) are another option to train on the raw pixel data given their greater usage in image processing, however training times and GPU resources were important factors to take into account given the on-field applications of the research.

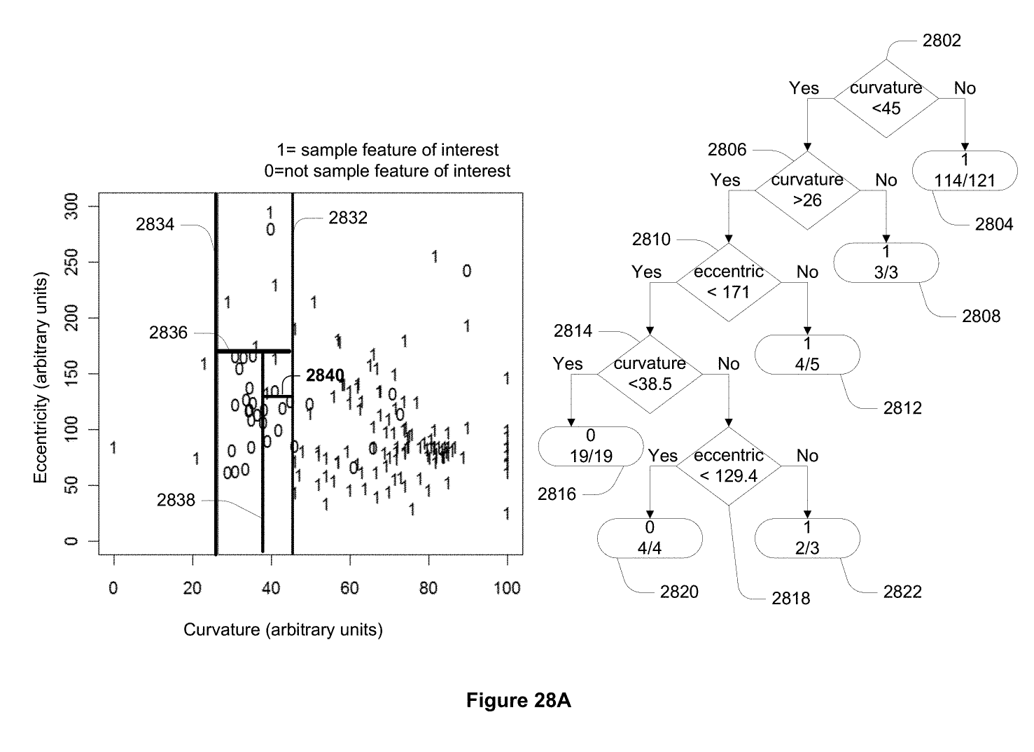

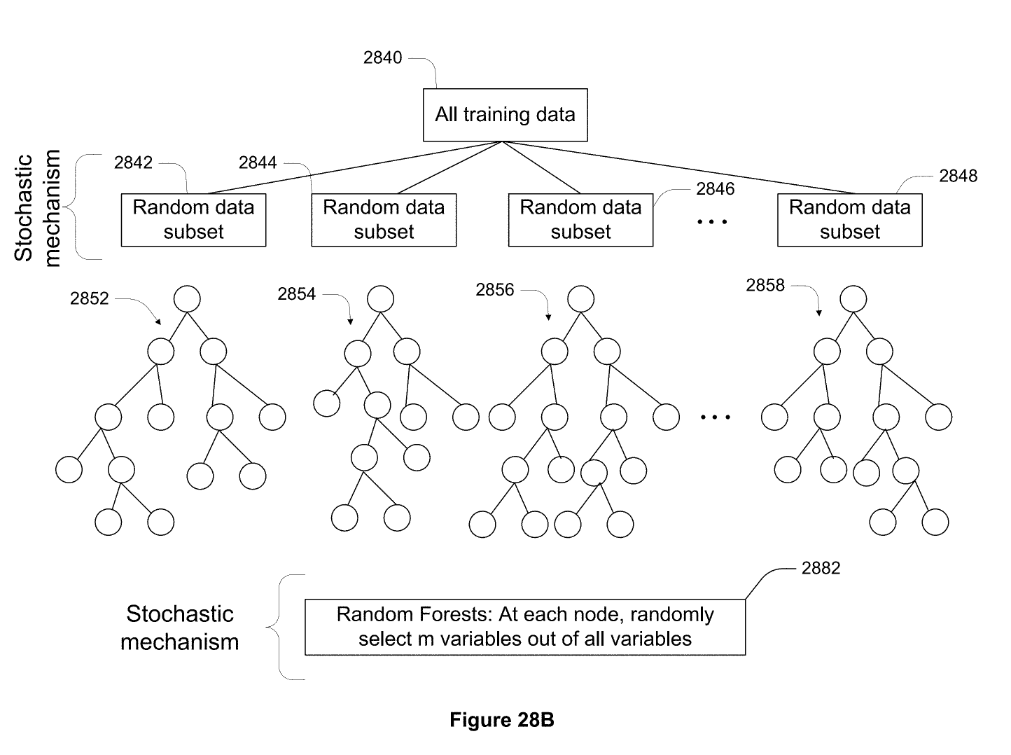

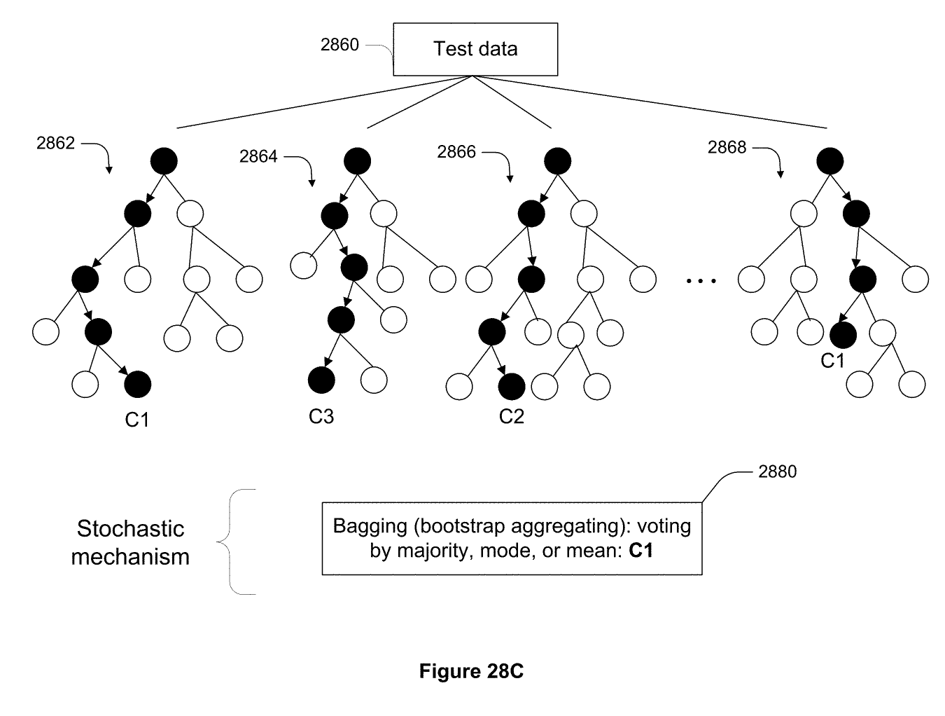

FIGS. 28A, 28B, and 28C schematically illustrate how a random forests classifier can be built and applied to classify feature vectors obtained from the PCA of the cellular artifact images. FIG. 28A shows hypothetical dataset having only two dimensions on the left and the hypothetical decision tree on the right that is trained from the hypothetical dataset. In this simplified illustrative example, each feature vector includes only two components; curvature and eccentricity. Each data point (or sample feature) is labeled as either 1 (feature of interest) or 0 (not feature of interest). Plotted on the x-axis on the left of the figure is curvature expressed in an arbitrary unit. Plotted on the y-axis is eccentricity expressed in an arbitrary unit. The data shown in the figure are used to train the decision tree. Once the decision tree is trained, testing data may be applied to the decision tree classify the test data.

At decision node 2802, the decision is based on whether or not the curvature value is smaller than 45. See the decision boundary 2832. If the decision is no, the feature is classified as a feature of interest. According to the training data here, 114 of 121 sample features are labeled as samples feature of interest. See block 2804. If the curvature is smaller than 45, the next decision node 2806 determines whether the curvature value is larger than 26. See decision boundary 2834. If not, the sample feature is determined to be a sample feature of interest. See block 2808. Three out of three of the sample features in the training data are indeed sample features of interest. If the curvature is smaller than 26, the next decision node 2810 determines whether centricity is smaller than 171. See decision boundary 2836. If no, the sample feature is determined to be a sample feature of interest. See block 2812. Four out of five training data points are indeed sample features of interest. Further decision nodes are further generated in the same manner until a criterion is met.

As apparent from the illustrative example in FIG. 28A, as more branches are created, more of the data points can be correctly classified. However, if the tree becomes too large, the lower branches of the decision tree tend to generate poorly to new data not used to train the model, manifesting overfitting the tree to the training data. One approach to avoid overfitting is to grow the trees relatively extensively to have a large number of branches, and then prune back the unnecessary branches. Various methods for pruning trees have been developed. For instance, cross-validation data can be used to prune branches. Using cross-validation data not used to train the tree, one can test the predictive power of a decision tree. Decision branches that do not improve the predictive power of the tree for the cross-validation data can be pruned back or removed. Bayesian criteria may also be used to prune decision trees.

The same decision tree as illustrated above may be modified to classify more than two classes. The decision trees may also be modified to predict a continuous dependent variable. Therefore, these applications of the decision trees are also called classification and regression trees (CARTs). Classification or regression trees have various advantages. For example, they are computationally simple and quick to fit, even for large problems. They do not assume normal distributions of the variables, providing nonparametric statistical approaches. However, classification and regression trees have lower accuracy compared to other machine learning methods such as support vector machines and neural network models. Also, CARTs tend to be unstable, where a small change of the data may cause a large change of the decision tree. To overcome these disadvantages, stochastic mechanisms can be combined with decision trees using bootstrap aggregating (Bagging) and Random Forest.

FIGS. 28B and 28B illustrate using an ensemble of decision trees to perform classification including the stochastic mechanisms of the bootstrap aggregating (bagging) and Random Forest. In bagging, random data subset are selected from all available training data to train the decision trees. For example, a data subset 2842 is randomly selected with replacement from all training data 2840. The random data subset is also called a bootstrap data subset. The random data subset 2842 is then used it to train the decision tree 2852. Many more random data subsets (2844-2848) are randomly selected as bootstrap data subsets and used to train decision trees 2854-2858.

In some implementations, the decision trees' predictive powers are evaluated using training data outside of the bootstrap data set. For instance, if a training data point is not selected in the data subset 2842, it can be used to test the predictive power of the decision tree 2852. Such testing is termed “out of the bag” or “oob” validation. In some implementations, decision trees having poor oob predictive power may be removed from the ensemble. Other methods such as cross-validation may also be used to remove low performing trees.

After the decision trees are trained and pruned, test data may be provided to the ensemble of decision trees to classify the test data. FIG. 28C illustrates how test data may be applied to an ensemble of decision trees to classify the test data 2860. For example, a test data point has one decision path in decision tree 2862 and is classified as C1. The same data point may be classified as C3 by decision tree 2864, as C2 by decision tree 2866, and C1 by decision tree 2868, and so on. Bagging method determines the final classification result by combining the results of all the individual decision trees. See block 2880. In classification applications, bagging can determine the final classification by voting by majority. It can also be determined as the mode of the classification distributions. Therefore, in the example illustrated here, the test data point is classified as C1 by the ensemble of decision trees. In regression, bagging can determine the final classification by mean, mode, or median, weighted average, and other methods of combining outcomes from multiple trees.

Random Forest is further improves on bagging by integrating an additional stochastic mechanism into the ensemble of decision trees. In a Random Forest method, at each node of the decision tree, m variables are randomly selected from all of the available variables to train the decision node. See block 2882. It has been shown that the additional stochastic mechanism improve the accuracy and stability of the model.

Neural Networks

In certain implementations, a neural network of this disclosure, e.g., a convolutional neural network, takes as input the pixel data of cellular artifacts extracted through segmentation. The pixels making up the cellular artifact are divided into slices of predetermined sizes, with each slice being fed to a different node at an input layer of the neural network. The input nodes operate on their respective slices of pixels and feed the resulting computed outputs to nodes on a next layer of the neural network, which layer is deemed a hidden layer of the neural network. Values calculated at the nodes of this second layer of the network are then fed forward to a third layer of the neural network where the nodes of the third layer act on the inputs they receive from the second layer and generate new values which are fed to a fourth layer. The process continues layer-by-layer until values reach an output layer containing nodes representing the separate classifications for the input cellular artifact pixels. As an example, one node of the output layer may represent a normal B cell, another node of the output layer may represent a cancerous B cell, yet another node of the output layer may represent an anucleated red blood cell, and yet still a further output node may represent a malarial parasite. After execution of the classification, each of the output nodes may be probed to determine whether the output is true or false. A single true value classifies the input cellular artifact.

Typically, the various layers of a convolutional neural network correspond to different levels of abstraction associated with the classification process. For example, some inner layers may correspond to classification based on a coarse outer shape of the cellular artifact (e.g., circular, non-circular ellipsoidal, sharp angled, etc.), while other inner layers may correspond to a texture of the interior of the cellular artifact, a smoothness of the perimeter of the cellular artifact, etc. In general, there are no fast rules governing which layers conduct which particular aspects of the classification process. The training of the neural network simply defines nodes and connections between nodes such that the model accurately classifies cellular artifacts from an image of the biological sample.

Convolutional neural networks include multiple layers of receptive fields. As known to those of skill in the art, these layers mimic small neuron collections that process portions of the input image. Individual nodes of these layers receive a limited portion of the cellular artifact. The receptive fields of the nodes partially overlap such that they tile the visual field. The response of a node to its portion of the cellular artifact is treated mathematically by a convolutional operation. The outputs of the nodes in a layer of a convolution network are then arranged so that their input regions overlap, to obtain a better representation of the original image. This may be repeated for every such layer. Tiling allows to the neural network to tolerate translation of the input image.

The convolutional layer's parameters include a set of learnable filters (or kernels), which have a small receptive field, but extend through the full depth of the input volume. In certain embodiments, during the forward pass, each filter is convolved across the width and height of the input volume, computing the dot product between the entries of the filter and the input and producing a two-dimensional activation map of that filter. As a result, the network learns filters that activate when they see some specific type of feature at some spatial position in the input.

Stacking the activation maps for all filters along the depth dimension forms the full output volume of the convolution layer. Every entry in the output volume can thus also be interpreted as an output of a neuron that looks at a small region in the input and shares parameters with neurons in the same activation map.

Convolutional networks may include local or global pooling layers, which combine the outputs of neuron clusters. They also include various combinations of convolutional and fully connected layers. The neural network may include convolution, avg pool, max pool layers stacked on top of each other in order to best represent the segmented image data.

In certain embodiments, the deep learning image classification model may employ TensorFlow™ routines available from Google of Mountain View, Calif. Some implementations may employ Google's simplified inception net architecture.

Diagnosing Conditions

Various types of condition (e.g., medical conditions) may be identified using systems and methods of this disclosure. For example, the simple presence of a pathogen or unexpected (abnormal) cell associated with a condition (e.g., a disease) may be a condition. In certain embodiments, the direct output from the machine learning model provides a condition; e.g., the model identifies a cellular artifact as a malarial parasite. Other conditions may be obtained indirectly from the output of the model.

For example, some conditions are associated with an unexpected/abnormal cell count or ratio of cell/organism types. In such cases, the direct outputs of a model (e.g., classifications of multiple cellular artifacts) are compared, accumulated, etc. to provide relative or absolute numbers of cellular artifact classes.

In some implementations, the classifier provides at least one of two main types of diagnosis: positive identification of a specific organism or cell type, and quantitative analysis of cells or organisms classified as a particular type or of multiple types, whether host cells or non-host cells. One class of host cell quantitation counts leukocytes. Cell count information may be absolute or differential (e.g., ratios of two different cell types). As an example, an absolute red blood cell count lower than a reference range is considered anemic.

Certain immune-related conditions consider absolute counts of leukocytes (e.g., of of all types). In one example, absolute counts greater than about 30,000/ml indicate leukemia or other malignant condition, while counts between about 10,000 and about 30,000 indicate a serious infection, inflammation, and/or sepsis. A leukocyte count of greater than about 30,000/ml may suggest a biopsy for example. At the other end of the range, leukocyte counts of less than about 4000/ml suggest leukopenia. Neutrophils (a type of leukocyte) may be counted separately; absolute counts less than about 500/ml suggests neutropenia. When such condition is diagnosed, the patient is seriously compromised in her ability to fight infections and she may be prescribed a neutrophil boosting treatment.

In one embodiment, a white blood cell counter uses image analysis as described herein and provides a semi-quantitative determination of white blood cells count in capillary or venous whole blood. The determinations are Low (below 4,500 WBCs/μL), Normal (between 4,500 WBCs/μL and 10,000 WBCs/μL) and High (greater than 10,000 WBCs/μL).

In some cases, leukocyte differentials or ratios are used to indicate particular conditions. For example, ratios or differential counts of the five leukocyte types represent responses to different types of conditions. For example, neutrophils primarily address bacterial infections, while lymphocytes primarily address viral infections. Other types of white blood cell include monocytes, eosinophils, and basophils. In some embodiments, eosinophils counts greater than 4-5% of the WBC population are flagged for allergic/asthmatic reactions to a stimuli. Other examples of conditions associated with differential counts of the various types of leukocytes (e.g., neutrophils, lymphocytes, monocytes, eosinophils, and basophils) include the following conditions.

The condition of an abnormally high level of neutrophils is known as neutrophilia. Examples of causes of neutrophilia include but are not limited to: acute bacterial infections and also some infections caused by viruses and fungi; inflammation (e.g., inflammatory bowel disease, rheumatoid arthritis); issue death (necrosis) caused by trauma, major surgery, heart attack, burns; physiological (stress, rigorous exercise); smoking; pregnancy—last trimester or during labor; and chronic leukemia (e.g., myelogenous leukemia).

The condition of an abnormally low level of neutrophils is known as neutropenia. Examples of causes of neutropenia include but are not limited to: myelodysplastic syndrome; severe, overwhelming infection (e.g., sepsis—neutrophils are used up); reaction to drugs (e.g., penicillin, ibuprofen, phenytoin, etc.); autoimmune disorder; chemotherapy; cancer that spreads to the bone marrow; and aplastic anemia.

The condition of an abnormally high level of lymphocytes is known as lymphocytosis. Examples of causes of lymphocytosis include but are not limited to: acute viral infections (e.g., hepatitis, chicken pox, cytomegalovirus (CMV), Epstein-Barr virus (EBV), herpes, rubella); certain bacterial infections (e.g., pertussis (whooping cough), tuberculosis (TB)); lymphocytic leukemia; and lymphoma.

The condition of an abnormally low level of lymphocytes is known as lymphopenia or lymphocytopenia. Examples of causes of lymphopenia include but are not limited to: autoimmune disorders (e.g., lupus, rheumatoid arthritis; infections (e.g., HIV, TB, hepatitis, influenza); bone marrow damage (e.g., chemotherapy, radiation therapy); and immune deficiency.

The condition of an abnormally high level of monocytes is known as monocytosis. Examples of causes of monocytosis include but are not limited to: chronic infections (e.g., tuberculosis, fungal infection); infection within the heart (bacterial endocarditis); collagen vascular diseases (e.g., lupus, scleroderma, rheumatoid arthritis, vasculitis); inflammatory bowel disease; monocytic leukemia; chronic myelomonocytic leukemia; and juvenile myelomonocytic leukemia.

The condition of an abnormally low level of monocytes is known as monocytopenia. Isolated low-level measurements of monocytes may not be medically significant. However, repeated low -level measurements of monocytes may indicate bone marrow damage or hairy-cell leukemia.

The condition of an abnormally high level of eosinophils is known as eosinophilia. Examples of causes of eosinophilia include but are not limited to: asthma, allergies such as hay fever; drug reactions; inflammation of the skin (e.g., eczema, dermatitis); parasitic infections; inflammatory disorders (e.g., celiac disease, inflammatory bowel disease); certain malignancies/cancers; and hypereosinophilic myeloid neoplasms.

The condition of an abnormally low level of eosinophils is known as eosinopenia. Although the level of eosinophil is typically low, its causes may still be associated with cell counts under certain conditions.

The condition of an abnormally high level of basophils is known as basophilia. Examples of causes of basophilia include but are not limited to: rare allergic reactions (e.g., hives, food allergy); inflammation (rheumatoid arthritis, ulcerative colitis); and some leukemias (e.g., chronic myeloid leukemia).

The condition of an abnormally low level of basophils is known as basopenia. Although the level of basophils is typically low, its causes may still be associated with cell counts under certain conditions.

To diagnose a condition, the image analysis results (positive identification of a cell type or organism and/or quantitative information about numbers of cells of organisms) may be used in conjunction with other manifestations of the condition such as a patient exhibiting a fever. As another example, the diagnosis of leukemia can be aided by high counts of non-host cells such as bacteria. Generally, as infections get more severe, the counts increase.

### Context for Disclosed Computational Embodiments

The embodiments disclosed herein may be implemented as a system for topographical computer vision through automatic imaging, analysis and classification of physical samples using machine learning techniques and/or stage-based scanning.

Any of the computing systems described herein, whether controlled by end users at the site of the sample or by a remote entity controlling a machine learning model, can be implemented as software components executing on one or more general purpose processors or specially designed processors such as programmable logic devices (e.g., Field Programmable Gate Arrays (FPGAs)) and/or Application Specific Integrated Circuits (ASICs) designed to perform certain functions or a combination thereof. In some embodiments, code executed during operation of image acquisition systems and/or machine learning models (computational elements) can be embodied by a form of software elements which can be stored in a nonvolatile storage medium (such as optical disk, flash storage device, mobile hard disk, etc.), including a number of instructions for making a computer device (such as personal computers, servers, network equipment, etc.). Image acquisition algorithms, machine learning models and/or other computational structures described herein may be implemented on a single device or distributed across multiple devices. The functions of the computational elements may be merged into one another or further split into multiple sub-modules.

The hardware device can be any kind of device that can be programmed including, for example, any kind of computer including smart mobile devices (watches, phones, tablets, and the like), personal computers, powerful servers or supercomputers, or the like. The device includes one or more processors such as an ASIC or any combination processors, for example, one general purpose processor and two FPGAs. The device may be implemented as a combination of hardware and software, such as an ASIC and an FPGA, or at least one microprocessor and at least one memory with software modules located therein. In various embodiments, the system includes at least one hardware component and/or at least one software component. The embodiments described herein could be implemented in pure hardware or partly in hardware and partly in software. In some cases, the disclosed embodiments may be implemented on different hardware devices, e.g., using a plurality of CPUs.

Each computational element may be implemented as an organized collection of computer data and instructions. In certain embodiments, an image acquisition algorithm and a machine learning model can each be viewed as a form of application software that interfaces with a user and with system software. System software typically interfaces with computer hardware, typically implemented as one or more processors (e.g., CPUs or ASICs as mentioned) and associated memory. In certain embodiments, the system software includes operating system software and/or firmware, as well as any middleware and drivers installed in the system. The system software provides basic non-task-specific functions of the computer. In contrast, the modules and other application software are used to accomplish specific tasks. Each native instruction for a module is stored in a memory device and is represented by a numeric value.

At one level a computational element is implemented as a set of commands prepared by the programmer/developer. However, the module software that can be executed by the computer hardware is executable code committed to memory using “machine codes” selected from the specific machine language instruction set, or “native instructions,” designed into the hardware processor. The machine language instruction set, or native instruction set, is known to, and essentially built into, the hardware processor(s). This is the “language” by which the system and application software communicates with the hardware processors. Each native instruction is a discrete code that is recognized by the processing architecture and that can specify particular registers for arithmetic, addressing, or control functions; particular memory locations or offsets; and particular addressing modes used to interpret operands. More complex operations are built up by combining these simple native instructions, which are executed sequentially, or as otherwise directed by control flow instructions.

The inter-relationship between the executable software instructions and the hardware processor is structural. In other words, the instructions per se are a series of symbols or numeric values. They do not intrinsically convey any information. It is the processor, which by design was preconfigured to interpret the symbols/numeric values, which imparts meaning to the instructions.

The classifiers used herein may be configured to execute on a single machine at a single location, on multiple machines at a single location, or on multiple machines at multiple locations. When multiple machines are employed, the individual machines may be tailored for their particular tasks. For example, operations requiring large blocks of code and/or significant processing capacity may be implemented on large and/or stationary machines not suitable for mobile or field operations. Such operations may be implemented on hardware remote from the site where the sample is processed; e.g., on a server or server farm connected by a network to a field device that captures the sample image. Less computationally intensive operations may be implemented on a portable or mobile device used in the field for image capture.

Various divisions of labor are possible. In some implementations, a mobile device used in the field contains processing logic to coarsely discriminate between leukocytes, erythrocytes, and pathogens, and optionally to provide counts for each of these. In some cases, the processing logic includes image capture logic, segmentation logic, and course classification logic, with the latter optionally implemented as a random forest model. These logic components may be implemented as relatively small blocks of code that do not require significant computational resources.

In some implementations, logic that executes remotely (e.g., on a remote server or even supercomputer) discriminates between different types of leukocyte. As an example, such logic can classify eosinophils, monocytes, lymphocytes, basophils, and neutrophils. Such logic may be implemented as a deep learning convolutional neural network and require relatively large blocks of code and significant processing power. With the leukocytes correctly identified, the system may additionally execute differential models for diagnosing conditions based on differential amounts of various combinations of the five leukocyte types.

### EXAMPLES

Accuracy

The objective was to demonstrate that a white blood cell analysis system using machine learning and a test strip as described above in connection with FIG. 6 (also referred to as a WBC System) generates accurate results throughout the indicated usage range (2 k to 20 k WBC/μL), especially when samples are near the cutoff points of Low (Below 4.5 k WBCs/μL), Normal (Between 4.5 k WBCs/μL and 10 k WBCs/μL) and High (>10 k WBCs/μL).

Control blood samples were diluted to seven concentrations (2 k, 4 k, 5.5 k, 9 k, 11 k, 15 k, and 20 k WBC/μL) throughout the range. There were twenty samples for each concentration. Each sample was loaded onto a test strip. After five minutes of waiting, the test strip was placed inside the device. The result of the device was recorded in Table 3.

TABLE 3
Count and Accuracy of Samples at Different Concentrations

| # | Actual | Categorization | | | |
|---|---|---|---|---|---|
| Sam- | Value | 1 (<4.5k | 2 (4.5k-10k | 3 (>10k | Accuracy |
| ples | (WBC/μL) | WBC/μL) | WBC/μL) | WBC/μL) | (%) |
| 20 | 2k | 20 | 0 | 0 | 100 |
| 20 | 4k | 20 | 0 | 0 | 100 |
| 20 | 5.5k | 0 | 20 | 0 | 100 |
| 20 | 9k | 0 | 20 | 0 | 100 |
| 20 | 11k | 0 | 0 | 20 | 100 |
| 20 | 15k | 0 | 0 | 20 | 100 |
| 20 | 20k | 0 | 0 | 20 | 100 |

The results indicate that the conditional probability of a correct result is 100% for results categorized at <4.5 k WBC/μL, 100% for results categorized between 4.5-10 k WBC/μL, and 100% for results categorized as >10 k WBC/μL. The data supports that WBC System results are accurate throughout the indicated range (2 k-20 k WBC/μL) and in the vicinity of cut-off thresholds.

Precision

The objective of this study was to establish the measurement precision of the WBC System. A parent vial of 10̂8 white blood cells was diluted to create solutions of seven different concentrations (2 k, 4 k, 5.5 k, 9 k, 11 k, 15 k, 20 k WBC/μL).

4 μL of solution 1 was loaded onto twenty test strips. Each strip was inserted into the device five minutes after the strip was loaded with solution. Results were generated by the machine and recorded.

The machine was powered off completely and was turned on again after two hours. (Because white blood cells are not stable over time, time periods within a single day were substituted for days in the measurement of precision). 4 μL of solution 1 was loaded onto another 20 test strips. Each strip was inserted into the device five minutes after the strip was loaded with solution. Results were generated by the machine and recorded in Table 4. The same procedure was performed across all seven solutions.

TABLE 4
Count of Samples at Different Concentrations Across Two Setups

| | | Categorization | | | Categorization | | |
|---|---|---|---|---|---|---|---|
| Number | | (Setup 1) | | | (Setup 2) | | |
| of Samples | Concentration | 1 | 2 | 3 | 1 | 2 | 3 |
| 20 | 2k | 20 | 0 | 0 | 20 | 0 | 0 |
| 20 | 4k | 20 | 0 | 0 | 20 | 0 | 0 |
| 20 | 5.5k | 0 | 20 | 0 | 0 | 20 | 0 |
| 20 | 9k | 0 | 20 | 0 | 0 | 20 | 0 |
| 20 | 11k | 0 | 0 | 20 | 0 | 0 | 20 |
| 20 | 15k | 0 | 0 | 20 | 0 | 0 | 20 |
| 20 | 20k | 0 | 0 | 20 | 0 | 0 | 20 |

The within-run precision and total precision are shown in Table 5.

TABLE 5
Precision at Different Concentrations

| | |
|---|---|
| Within-Run Precision | Total Precision |

| | SD | CV | SD | CV |
|---|---|---|---|---|
| Concentration | (WBC/μL) | (%) | (WBC/μL) | (%) |
| 2k | 0 | 0 | 0 | 0 |
| 4k | 0 | 0 | 0 | 0 |
| 5.5k | 0 | 0 | 0 | 0 |
| 9k | 0 | 0 | 0 | 0 |
| 11k | 0 | 0 | 0 | 0 |
| 15k | 0 | 0 | 0 | 0 |
| 20k | 0 | 0 | 0 | 0 |

The results indicate that setup and takedown does not affect the results generated by the system. The results were both accurate and precise before and after takedown and setup.

Linearity

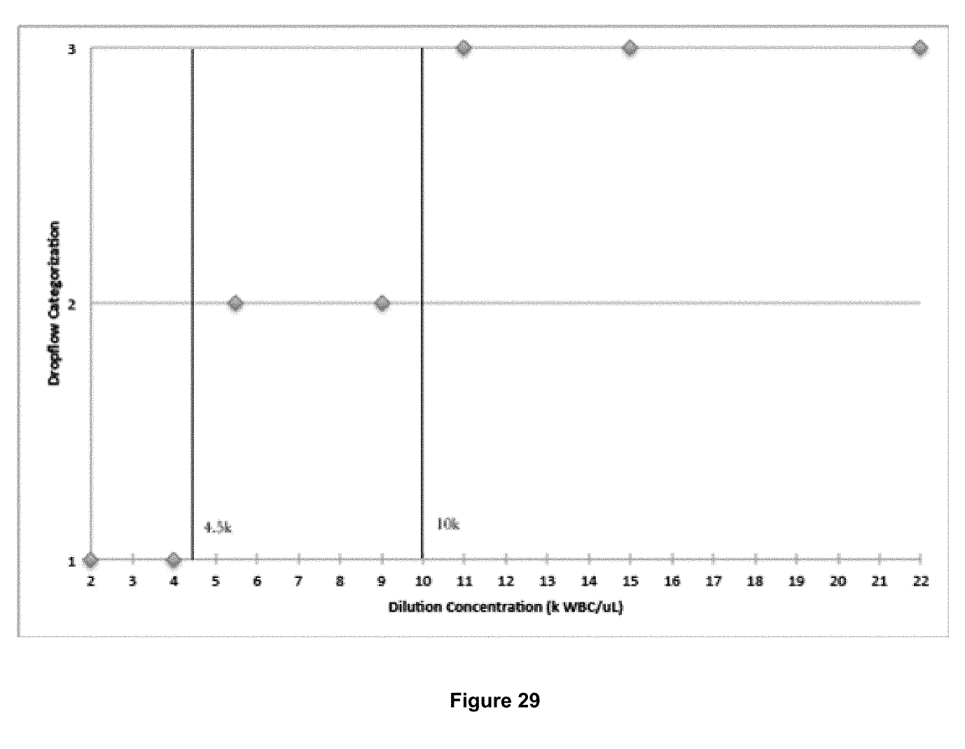

The objective of this study was to establish the measuring interval of the WBC System. A parent vial of 10̂8 white blood cells was diluted to create solutions of seven different concentrations (2 k, 4 k, 5.5 k, 9 k, 11 k, 15 k, 20 k WBC/μL). At each concentration, 20 samples were tested in the WBC System. The results were generated and plotted in FIG. 29.

The method used in the WBC System has been demonstrated to be linear between 2 k/μL-20 k/μL within no difference in 2 k/μL and within no difference in 20 k/μL. The coefficient of determination (r̂2) for each category is 1.

Accuracy and Precision in Different Temperatures

The objective of this study was to establish the measurement accuracy of the Dropflow WBC System in different external environments. A parent vial of 10̂8 white blood cells was diluted to create solutions of seven different concentrations (2 k, 4 k, 5.5 k, 9 k, 11 k, 15 k, 20 k WBC/μL).

4 ul of solution 1 was loaded into 20 test strips. Five of each test strip was loaded and placed in four different temperatures (35 F, 45 F, 60 F, 70 F). Five minutes after each strip was loaded and placed in its assigned environment, it was placed into the machine to be read. Results were recorded. The same procedure was performed across all seven solutions. The sample counts and accuracies for different sample concentrations are shown blow in Tables 6-9, each table for one of four different temperatures.

TABLE 6
Sample Counts and Accuracies at 35 F. ° (Refrigeration)

| # | Actual | Categorization | | | |
|---|---|---|---|---|---|
| Sam- | Value | 1 (<4.5k | 2 (4.5k-10k | 3 (>10k | Accuracy |
| ples | (WBC/μL) | WBC/μL) | WBC/μL) | WBC/μL) | (%) |
| 20 | 2k | 20 | 0 | 0 | 100 |
| 20 | 4k | 20 | 0 | 0 | 100 |
| 20 | 5.5k | 0 | 20 | 0 | 100 |
| 20 | 9k | 0 | 20 | 0 | 100 |
| 20 | 11k | 0 | 0 | 20 | 100 |
| 20 | 15k | 0 | 0 | 20 | 100 |
| 20 | 20k | 0 | 0 | 20 | 100 |

TABLE 7
Sample Counts and Accuracies at 45 F. ° (Outside)

| # | Actual | Categorization | | | |
|---|---|---|---|---|---|
| Sam- | Value | 1 (<4.5k | 2 (4.5k-10k | 3 (>10k | Accuracy |
| ples | (WBC/μL) | WBC/μL) | WBC/μL) | WBC/μL) | (%) |
| 20 | 2k | 20 | 0 | 0 | 100 |
| 20 | 4k | 20 | 0 | 0 | 100 |
| 20 | 5.5k | 0 | 20 | 0 | 100 |
| 20 | 9k | 0 | 20 | 0 | 100 |
| 20 | 11k | 0 | 0 | 20 | 100 |
| 20 | 15k | 0 | 0 | 20 | 100 |
| 20 | 20k | 0 | 0 | 20 | 100 |

TABLE 8
Sample Counts and Accuracies at 60 F. ° (Outside)

| # | Actual | Categorization | | | |
|---|---|---|---|---|---|
| Sam- | Value | 1 (<4.5k | 2 (4.5k-10k | 3 (>10k | Accuracy |
| ples | (WBC/μL) | WBC/μL) | WBC/μL) | WBC/μL) | (%) |
| 20 | 2k | 20 | 0 | 0 | 100 |
| 20 | 4k | 20 | 0 | 0 | 100 |
| 20 | 5.5k | 0 | 20 | 0 | 100 |
| 20 | 9k | 0 | 20 | 0 | 100 |
| 20 | 11k | 0 | 0 | 20 | 100 |
| 20 | 15k | 0 | 0 | 20 | 100 |
| 20 | 20k | 0 | 0 | 20 | 100 |

TABLE 9
Sample Counts and Accuracies at 70 F. ° (Inside)

| # | Actual | Categorization | | | |
|---|---|---|---|---|---|
| Sam- | Value | 1 (<4.5k | 2 (4.5k-10k | 3 (>10k | Accuracy |
| ples | (WBC/μL) | WBC/μL) | WBC/μL) | WBC/μL) | (%) |
| 20 | 2k | 20 | 0 | 0 | 100 |
| 20 | 4k | 20 | 0 | 0 | 100 |
| 20 | 5.5k | 0 | 20 | 0 | 100 |
| 20 | 9k | 0 | 20 | 0 | 100 |
| 20 | 11k | 0 | 0 | 20 | 100 |
| 20 | 15k | 0 | 0 | 20 | 100 |
| 20 | 20k | 0 | 0 | 20 | 100 |

The results indicate that different temperatures within 35 F to 70 F do not impact the accuracy or precision of the results.

Aging

The objective of this study was to establish the measurement accuracy stability of the WBC System as samples aged. A parent vial of 10̂8 white blood cells was diluted to create solutions of seven different concentrations (2 k, 4 k, 5.5 k, 9 k, 11 k, 15 k, 20 k WBC/μL).

4 μL of solution 1 was loaded into 20 test strips. Each strip was inserted into the machine and a result was generated 5 minutes after the strip was loaded with solution (t=0). See Table 10. After a 1 hour wait (t=1), the readings were repeated for each strip. See Table 11. After an additional one hour wait (t=2), the readings were again repeated for each strip. See Table 12. The results were recorded. The procedure was repeated for each solution.

TABLE 10
Sample Performance for t = 0

| # | Actual | Categorization | | | |
|---|---|---|---|---|---|
| Sam- | Value | 1 (<4.5k | 2 (4.5k-10k | 3 (>10k | Accuracy |
| ples | (WBC/μL) | WBC/μL) | WBC/μL) | WBC/μL) | (%) |
| 20 | 2k | 20 | 0 | 0 | 100 |
| 20 | 4k | 20 | 0 | 0 | 100 |
| 20 | 5.5k | 0 | 20 | 0 | 100 |
| 20 | 9k | 0 | 20 | 0 | 100 |
| 20 | 11k | 0 | 0 | 20 | 100 |
| 20 | 15k | 0 | 0 | 20 | 100 |
| 20 | 20k | 0 | 0 | 20 | 100 |

TABLE 11
Sample Performance for t = 1

| # | Actual | Categorization | | | |
|---|---|---|---|---|---|
| Sam- | Value | 1 (<4.5k | 2 (4.5k-10k | 3 (>10k | Accuracy |
| ples | (WBC/μL) | WBC/μL) | WBC/μL) | WBC/μL) | (%) |
| 20 | 2k | 20 | 0 | 0 | 100 |
| 20 | 4k | 20 | 0 | 0 | 100 |
| 20 | 5.5k | 0 | 20 | 0 | 100 |
| 20 | 9k | 0 | 20 | 0 | 100 |
| 20 | 11k | 0 | 0 | 20 | 100 |
| 20 | 15k | 0 | 0 | 20 | 100 |
| 20 | 20k | 0 | 0 | 20 | 100 |

TABLE 12
Sample Performance for t = 2

| # | Actual | Categorization | | | |
|---|---|---|---|---|---|
| Sam- | Value | 1 (<4.5k | 2 (4.5k-10k | 3 (>10k | Accuracy |
| ples | (WBC/μL) | WBC/μL) | WBC/μL) | WBC/μL) | (%) |
| 20 | 2k | 20 | 0 | 0 | 100 |
| 20 | 4k | 20 | 0 | 0 | 100 |
| 20 | 5.5k | 0 | 20 | 0 | 100 |
| 20 | 9k | 0 | 20 | 0 | 100 |
| 20 | 11k | 0 | 0 | 20 | 100 |
| 20 | 15k | 0 | 0 | 20 | 100 |
| 20 | 20k | 0 | 0 | 20 | 100 |

The results indicate that aging of samples does not affect the results of the study for up to 2 hours of loading the sample onto the test strip. When the same samples were read 5 minutes after being loaded, 1 hour after being loaded, 2 hours after being loaded—the results were the same.

EDTA Interference Testing

The objective of this study was to investigate the potential interference effect of EDTA on the accuracy of the WBC System. EDTA was mixed to a blood sample that was in the categorization of 2 (4.5 k-10 k WBC/μL). The resulting mix contained 1.5 mg/mL of EDTA. 4 μL of the mix was loaded onto 20 test strips. Each strip was inserted into the device five minutes after the strip was loaded. Results are shown in Table 13.

TABLE 13
EDTA Interference Effect

| # | Actual | Categorization | | | |
|---|---|---|---|---|---|
| Sam- | Dropflow | 1 (<4.5k | 2 (4.5k-10k | 3 (>10k | Accuracy |
| ples | Categorization | WBC/μL) | WBC/μL) | WBC/μL) | (%) |
| 20 | 2 | 0 | 20 | 0 | 100 |

Given that the sample of EDTA prepared blood was within the known range of 2, it can be concluded that the EDTA did not interfere with the accuracy of the WBC System.

Clinical Performance Testing

The objective of the study was to demonstrate the accuracy of the WBC System in a clinical context. The study was conducted at the FEMAP Family Hospital in Juarez, Chihuahua, Mexico. A health-care professional (HCP) employed at the study site collected approximately 1 mL of blood from 103 unique patients. 2-3 μL of each blood sample was passed through the Beckman Coulter Counter. The WBC reading from the Coulter counter was recorded by the HCP. 2-3 μL of each blood sample was also loaded onto the test strips and run through the WBC System. The WBC categorization was recorded by the HCP.

Patients providing blood samples were a random sample of patients requiring complete blood count blood analyses. This included patients of normal health and patients who may have been suffering from various diseases.

Analysis of Performance

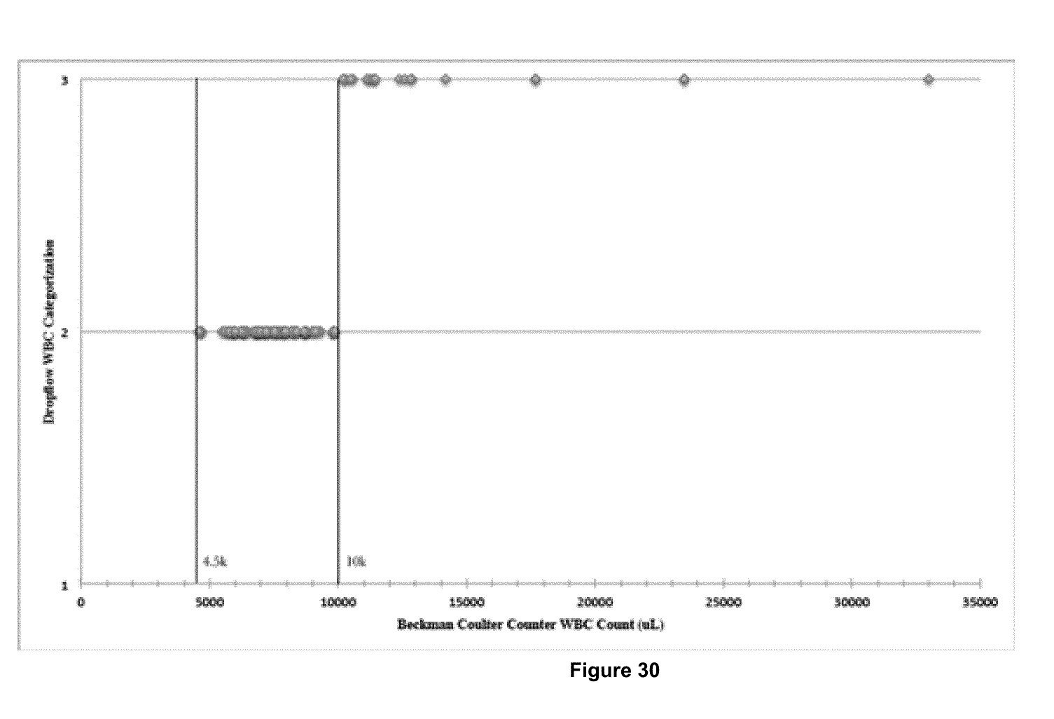

The results indicate that the conditional probability of a correct result is 100% for results categorized at <4.5 k WBC/μL, 100% for results categorized between 4.5-10 k WBC/μL, and 100% for results categorized as >10 k WBC/μL. Table 14 shows the cell count results using an implemented method versus the Beckman Coulter Counter results. FIG. 30 plots the cell count results.

TABLE 14
Cell Count Results

| | Number | | | |
|---|---|---|---|---|
| | of | Beckman Coulter Counter | | |
| Result | Samples | <4.5k WBC/μL | 4.5-10k WBC/μL | >10k WBC/μL |
| 1 (<4.5k | 0 | 0 | 0 | 0 |
| WBC/μL) | | | | |
| 2 (4.5-10k | 82 | 0 | 82 | 0 |
| WBC/μL) | | | | |
| 3 (>10k | 21 | 0 | 0 | 21 |
| WBC/μL) | | | | |

### Other Embodiments

The foregoing description of the specific embodiments explains the general nature of the embodiments herein such that others can, by applying current knowledge, readily modify and/or adapt for various applications such specific embodiments without departing from the generic concept, and, therefore, such adaptations and modifications are within the scope of the disclosed embodiments. It is to be understood that the phraseology or terminology employed herein is for the purpose of description and not of limitation. Therefore, those skilled in the art will recognize that the embodiments herein can be practiced with modification within the spirit and scope of the claims as described herein. For example, while most examples described operate on blood or other liquid biological samples, the disclosure is not so limited. In certain applications, the disclosed embodiments are employed in air purity analysis, biological sample counting, medical diagnostics, air-quality analysis, biopsy, etc.

None of the pending claims include limitations presented in “means plus function” or “step plus function” form. (See, 35 USC § 112(f)). It is Applicant's intent that none of the claim limitations be interpreted under or in accordance with 35 U.S.C. § 112(f).

1. A system for identifying a sample feature of interest in a biological sample of a host organism, the system comprising:
a camera configured to capture one or more images of the biological sample; and
one or more processors communicatively connected to the camera, the one or more processors being configured to:
receive the one or more images of the biological sample captured by the camera;
segment the one or more images of the biological sample to obtain a plurality of cellular artifacts;
apply a machine-learning classification model to the plurality of images of cellular artifacts to classify the cellular artifacts; and
determine that at least one of the classified cellular artifacts belongs to a class to which the sample feature of interest belongs.

2. The system of claim 1, wherein the sample feature of interest is associated with a disease.

3. The system of claim 2, wherein the one or more processors are further configured to diagnose the disease in the host organism based at least partly on determining that the at least one of the classified cellular artifacts belongs to the class to which the sample feature of interest belongs.

4. The system of claim 3, wherein the diagnosis of the disease in the host organism is further based on a quantity of the classified cellular artifacts obtained from the image that belong to the same class as the sample feature of interest.

5. The system of claim 1, wherein the machine-learning classification model comprises a convolutional neural network classifier.

6. The system of claim 1, wherein applying the machine-learning classification model to the plurality of images of cellular artifacts to classify the cellular artifacts comprises:
applying a principal component analysis (PCA) to the plurality of images of cellular artifacts to obtain a plurality of feature vectors for the plurality of cellular artifacts; and
applying a random forest classifier to the plurality of feature vectors for the plurality of cellular artifacts to classify the cellular artifacts.

7. The system of claim 6, wherein the one or more processors are further configured to:
receive a plurality of images of training cellular artifacts and classification data of the training cellular artifacts, wherein one or more of the training cellular artifacts belong to the same class as the sample feature of interest;
apply the principal component analysis to the plurality of training images of cellular artifacts to obtain a plurality of feature vectors for the plurality of training cellular artifacts; and
train the random forest classifier using the plurality of feature vectors for the plurality of training cellular artifacts and the classification data of the training cellular artifacts.

8. (canceled)

9. The system of claim 1, wherein the sample feature of interest is selected from the group consisting of: abnormal host cells, parasites infecting the host, and a combination thereof.

10. The system of claim 9, wherein the parasites infecting the host are selected from the group consisting of bacteria, fungi, protozoa, helminths, and any combinations thereof.

11.-13. (canceled)

14. The system of claim 1, wherein the one or more images of the biological sample comprise one or more images of a sample smear of the biological sample.

15. The system of claim 14, wherein the sample smear of the biological sample comprises a mono-cellular layer of the biological sample.

16. The system of claim 1, wherein segmenting the one or more images of the biological sample comprises converting the one or more images of the biological sample from color images to grayscale images.

17. The system of claim 16, wherein segmenting the one or more images of the biological sample further comprises converting the grayscale images to binary images using Otsu thresholding.

18. The system of claim 1, wherein segmenting the one or more images of the biological sample further comprises performing a Euclidean distance transformation.

19. The system of claim 18, wherein segmenting the one or more images of the biological sample further comprises identifying local maxima of pixel values obtained from the Euclidian distance transformation.

20. The system of claim 19, wherein segmenting the one or more images of the biological sample further comprises applying a Sobel filter to the one or more images of the biological sample or images derived therefrom.

21. The system of claim 20, wherein segmenting the one or more images of the biological sample further comprises splicing the one or more images of the biological sample using the local maxima and data obtained from applying the Sobel filter, thereby obtaining the plurality of images of the cellular artifacts.

22. (canceled)

23. The system of claim 1, wherein the machine learning classification model is configured to classify the cellular artifacts as belonging to a white blood cell, a red blood cell, or a parasite.

24. The system of claim 1, wherein the machine learning classification model is configured to classify white blood cells as neutrophils, eosinophils, monocytes, basophils, and lymphocytes.

25. The system of claim 1, wherein the one or more processors are further configured to determine a property, other than classifying cellular artifacts, of the biological sample from the one or more images.

26. The system of claim 25, wherein the property other than classifying cellular artifacts comprises an absolute or differential count of at least one type of cell.

27. (canceled)

28. A system for imaging a biological sample of a host organism, the system comprising:
a stage configured to receive the biological sample;
a camera configured to capture one or more images of the biological sample received by the stage;
one or more actuators coupled to the camera and/or the stage; and
one or more processors communicatively connected to the camera and the one or more actuators, the one or more processors being configured to:
receive the one or more images of the biological sample captured by the camera,
segment the one or more images of the biological sample to obtain one or more images of cellular artifacts, and
control, based on data obtained from the one or more images of cellular artifacts, the one or more actuators to move the camera and/or the stage in a first dimension.

29.-42. (canceled)

43. A method for identifying a sample feature of interest in a biological sample of a host organism, implemented with a system comprising one or more processors, the method comprising:
obtaining one or more images of the biological sample, wherein the images were obtained using a camera;
segmenting, by the one or more processors, the one or more images of the biological sample to obtain a plurality of images of cellular artifacts;
applying, by the one or more processors, a machine-learning classification model to the plurality of images of cellular artifacts to classify the cellular artifacts; and
determining, by the one or more processors, that at least one of the classified cellular artifacts belongs to a class to which the sample feature of interest belongs.

44. The method of claim 43, wherein the sample feature of interest is associated with a disease.

45. The method of claim 44, wherein the one or more processors are further configured to diagnose the disease in the host organism based at least partly on determining that the at least one of the classified cellular artifacts belongs to the class to which the sample feature of interest belongs.

46. The method of claim 45, wherein the diagnosing the disease in the host organism is further based on a quantity of the classified cellular artifacts belonging to the same class as the sample feature of interest.

47. The method of claim 43, wherein the machine-learning classification model comprises a convolutional neural network classifier.

48. The method of claim 43, wherein applying the machine-learning classification model to the plurality of images of cellular artifacts to classify the cellular artifacts comprises:
applying, by the one or more processors, a principal component analysis to the plurality of images of cellular artifacts to obtain a plurality of feature vectors for the plurality of cellular artifacts; and
applying, by the one or more processors, a random forest classifier to the plurality of feature vectors for the plurality of cellular artifacts to classify the cellular artifacts.

49. The method of claim 48, the method further comprises, before applying the machine-learning classification model to the plurality of images of cellular artifacts:
receiving, by at least one processor, a plurality of images of training cellular artifacts and classification data of the training cellular artifacts, wherein one or more of the training cellular artifacts belong to the same class as the sample feature of interest;
applying, by the at least one processor, the principal component analysis to the plurality of training images of cellular artifacts to obtain a plurality of feature vectors for the plurality of training cellular artifacts; and
training, by the at least one processor, the random forest classifier using the plurality of feature vectors for the plurality of training cellular artifacts and the classification data of the training cellular artifacts.

50. (canceled)

51. The method of claim 43, wherein the sample feature of interest is selected from the group consisting of: abnormal host cells, parasites infecting the host, and a combination thereof

52-53. (canceled)

54. The method of claim 43, wherein applying the machine learning classification model classifies the cellular artifacts as belonging to a white blood cell, a red blood cell, or a parasite.

55. The method of claim 43, wherein applying the machine learning classification model classifies white blood cells as neutrophils, eosinophils, monocytes, basophils, and lymphocytes.

56. The method of claim 43, further comprising determining a property, other than classifying cellular artifacts, of the biological sample from the one or more images.

57. The system of claim 56, wherein the property other than classifying cellular artifacts comprises an absolute or differential count of at least one type of cell.

58. (canceled)

59. A non-transitory computer-readable medium storing computer-readable program code to be executed by one or more processors, the program code comprising instructions to cause a system comprising a camera and one or more processors communicatively connected to the camera to:
obtain the one or more images of the biological sample captured using the camera;
segment, by the one or more processors, the one or more images of the biological sample to obtain a plurality of images of cellular artifacts;
apply, by the one or more processors, a machine-learning classification model to the plurality of images of cellular artifacts to classify the cellular artifacts; and
determine, by the one or more processors, that at least one of the classified cellular artifacts belongs to a class to which the sample feature of interest belongs.

60. A system comprising:
a smear producing device configured to receive a biological sample and spread it over a substrate to separate sample features of the biological sample such that the features can be viewed at different regions of the substrate;
a smear imaging device configured to take one more images that collectively capture all or a portion of the smear as provided on the substrate;
a deep learning classification model comprising computer readable instructions for executing on one or more processors, which when executing:
receive the one or more images from the smear imaging device;
segment the one or more images to identify groups of pixels containing images of sample features from the images, wherein each group of pixels comprises a cellular artifact; and
classify some or all of the cellular artifacts using the deep learning classification model, wherein the classification model discriminates between cellular artifacts created from images of at least one cell type of the host and images of at least one non-host feature.

61. The system of claim 60, wherein, when executing, the computer readable instructions segment the one or more images by (i) filtering background portions of the image and (ii) identifying contiguous groups of pixels in the foreground comprising the cellular artifacts.

62. The system of claim 60, wherein the computer readable instructions comprise instructions, which when executing, classify the cellular artifacts according to non-host features selected from the group consisting of protozoa present in the host, bacteria present in the host, fungi present in the host, helminths present in the host, and viruses present in the host.

63. A test strip for producing a smear of a liquid biological sample, the test strip comprising:
a substrate with a capillary tube disposed thereon, wherein the capillary tube is sized to form a smear of the biological sample when the biological sample enters the capillary tube;
a dry dye coated on at least a portion of the substrate, wherein the dye stains a particular cell type from the biological sample when the biological sample contacts the dye; and
a sample capture pathway disposed on the substrate and configured to receive the liquid biological sample onto the substrate and place the biological sample in contact with the dry dye and/or into the capillary tube where it forms a smear suitable for imaging.

64-71. (canceled)
